(19) United States
(12) Patent Application Publication
(10) Pub. No.: US 2022/0194708 A1
(43) Pub. Date: Jun. 23, 2022

(54) STORAGE AND PICKING SYSTEM, MOBILE MEASURED-VALUE DETECTION UNIT, AND METHOD FOR IMPROVED DETECTION OF MEASURED VALUES IN THE STORAGE AND PICKING SYSTEM

(71) Applicant: TGW Logistics Group GmbH, Marchtrenk (AT)

(72) Inventors: Markus GAGGL, Ansfelden (AT); Thomas MAHRINGER, Pucking (AT); Harald SCHROEPF, Wels (AT)

(73) Assignee: TGW Logistics Group GmbH, Marchtrenk (AT)

(21) Appl. No.: 17/441,867

(22) PCT Filed: Apr. 16, 2020
(86) PCT No.: PCT/AT2020/060154

§ 371 Date: Sep. 22, 2021

(30) Foreign Application Priority Data
Apr. 16, 2019 (AT) A 50345/2019

(51) Int. Cl. B65G 1/137

(52) U.S. Cl. CPC B65G 1/1375

(57) ABSTRACT

A mobile measurement-value acquisition unit has an autarkic power supply, a central processing unit and multiple sensors. The mobile measurement-value acquisition unit can acquire measured data on a movement path in a storage and picking system and store the location of the acquisition. During this process, the mobile measurement-value acquisition unit is moved along the movement path by conveyors of the storage and picking system and is optionally stopped on a storage location of the storage and picking system. Further, such measurement-value acquisition unit operates in a storage and picking system, and a method operates the storage and picking system.

The invention relates to a storage and picking system which comprises a storage zone, a workstation for picking and/or repacking articles, (a) conveying device(s) as well as a mobile measurement-value acquisition unit. The storage zone has a plurality of storage locations which form a storage surface for storing articles. The conveying device(s) comprise(s) motor-driven conveying means which have, or form, a moving transport surface and which are configured for transporting the articles on this transport surface inside the storage and picking system. The mobile measurement-value acquisition unit comprises an autarkic power supply, a central processing unit connected to the autarkic power supply and multiple sensors connected to the central processing unit. The mobile measurement-value acquisition unit is configured for acquiring a measurement value, a temporal development of a measurement value and/or a local distribution of measurement values of a physical parameter on a movement path (trajectory) of the mobile measurement-value acquisition unit in the storage and picking system with the help of the sensors. The mobile measurement-value acquisition unit is further configured for storing a location in the storage and picking system on which the measurement value, its temporal development and/or its local distribution was acquired.

The invention further relates to a mobile measurement-value acquisition unit for the above-mentioned storage and picking system operated in an automated manner

Finally, the invention relates to a method for acquiring measurement values in a storage and picking system of the above-mentioned kind in which the mobile measurement-value acquisition unit is moved along a movement path in the storage and picking system, and a measurement value, a temporal development of a measurement value and/or a local distribution of measurement values of a physical parameter on a movement path is acquired with the help of the sensors at a first point in time, and a location in the storage and picking system on which the measurement value, its temporal development and/or its local distribution was acquired is stored.

Traditionally, measured data are acquired in a storage and picking system of the known kind with the help of fixed-installation and/or stationary sensors, as well as with the help of sensors which are installed on movable devices of the storage and picking system (for example on, or in, storage-and-retrieval units and autonomous guided vehicles). Also the manual acquisition of measurement values with the help of portable devices in a storage and picking system is generally known.

It is problematic that the number of sensors which are stationary and/or installed on, or in, movable devices is limited for economic reasons alone, and a comprehensive collection of measured data is hence generally not possible, or possible only with difficulty. Also the manual acquisition of measurement values with the help of portable devices is possible only to a limited extent, as not all locations of a storage and picking system are easily accessible for individuals, and/or access often involves an at least partial shut-down of the storage and picking system. Also for this reason, a comprehensive collection of measured data is generally not possible, or possible only with difficulty.

It is hence an object of the present invention to specify an improved storage and picking system, an improved method for acquiring measurement values in a storage and picking system, as well as an improved mobile measurement-value acquisition unit. In particular, the possibilities for collecting measured data are to be increased considerably while keeping the technical and financial commitment relatively small

This object is achieved by means of a storage and picking system of the kind mentioned in the beginning in which the mobile measurement-value acquisition unit is configured for a transport on the transport surface of the motor-driven conveying means of the storage and picking system along the movement path (trajectory) and/or for an intermediate stop on the storage surface of the storage locations of the storage and picking system, which storage surface is situated on the movement path.

Said object is further achieved by means of a mobile measurement-value acquisition unit of the kind mentioned in the beginning which is configured for a transport on the transport surface of the motor-driven conveying means of the storage and picking system along the movement path and/or for an intermediate stop on the storage surface of the storage locations of the storage and picking system, which storage surface is situated on the movement path.

Finally, said object is achieved by means of a method of the kind mentioned in the beginning in which the mobile measurement-value acquisition unit is transported on the transport surface of the motor-driven conveying means of the storage and picking system along the movement path and/or is stopped on the storage surface of the storage locations of the storage and picking system, which storage surface is situated on the movement path.

Thus, the ambient conditions in different conveying sections and storage zones of the storage and picking system can be captured in a comprehensive manner Advantageously, the mobile measurement-value acquisition unit can reach all locations in the storage and picking system which are also provided for transporting or storing articles. Naturally, practically all relevant locations in the storage and picking system can thus be reached by the mobile measurement-value acquisition unit. The devices provided in the mobile measurement-value acquisition unit, i.e. in particular the central processing unit and the sensors of the mobile measurement-value acquisition unit, can hence be used in a variety of ways. As this is required basically only once for the entire storage and picking system, high-quality sensors can be used with no significant impact on the costs for the storage and picking system. Furthermore, a separate drive for the mobile measurement-value acquisition unit is not required, as a movement and/or a transport of same is possible with the help of the conveying means of the storage and picking system. This means that the mobile measurement-value acquisition unit need not have its own motor drive for its movement. As a result, the local and substantial scope of the possible measurements in a storage and picking system, as well as the quality of the measurement results, can be increased considerably while keeping costs low. In other words, the comprehensive collection of measured data is possible within the bounds of cost-efficiency.

Generally, the storage and picking system may comprise one, or multiple, (independently movable) mobile measurement-value acquisition units.

The movement path (trajectory) along which the mobile measurement-value acquisition unit is moved through the storage and picking system can be specified, for example, by a superordinate central control system (for example by a material flow computer or a warehouse maagement system) of the storage and picking system. In this case, the superordinate central control system (which is comprised by the storage and picking system), therefore, coordinates not only the movements of the articles (which can be transported and stored with or without loading aids), but the superordinate central control system also specifies the movement path of the mobile measurement-value acquisition unit. Alternatively, the movement path can also be specified by the mobile measurement-value acquisition unit itself, or by a remote control for the mobile measurement-value acquisition unit. The movement path can be specified randomly, for example. Also other strategies for specifying a movement path are possible, of course. The movement path can alternatively also be specified by an operator.

Within the scope of this disclosure, a measurement value, a temporal development of a measurement value and/or a local distribution of measurement values of a physical parameter can also be collectively referred to, and used synonymously with, the general term “measured data.” It should also be noted in this context that a physical parameter may also be the differential of another physical parameter. Accordingly, “measured data” can also be obtained by computing other measured data.

Measured data can be transferred to a receiving device of an operator in real time, or they are stored temporarily and transferred to the receiving device at a later point in time. The transfer can be done via a wireless or wired data interface, in particular via an air interface or a wired interface. The latter may in particular be provided at a charging station for the autarkic power supply of the measurement-value acquisition unit, which is called at periodically.

The acquisition of measured data by means of the mobile measurement-value acquisition unit can be done during the transport movement or during standstill. For example, the mobile measurement-value acquisition unit can acquire measured data on a storage location of the storage zone, also over a longer period of time. For example, vibrations in a storage rack can be acquired in this way.

The central processing unit can, in particular, comprise a microcontroller, an industrial computer (in particular in combination with a database) or a programmable logic controller, “PLC” in short, or be formed by same.

It should also be noted in this context that measured data can be acquired in a storage and picking system (simultaneously) by mobile measurement-value acquisition units of different designs. For example, simply-structured measurement-value acquisition units may be provided for narrowly defined measurement tasks, for example for the measurement of only a single, or only a few, measuring parameters, for instance during a long-term use in a storage rack. On the other hand, universally-usable mobile measurement-value acquisition units which are equipped with a large number of different sensors may be provided.

The conveying device(s) may comprise stationary and motor-driven conveying means and/or mobile (location-independent) and motor-driven conveying means for transporting articles and the mobile measurement-value acquisition unit. The conveying device(s) can, in particular, be subdivided into “stationary conveying device(s)” (in particular comprising “belt conveyors” and/or “overhead conveyors”) and “conveying vehicles operated in an automated manner.”

The conveying device(s) connect(s), in particular, the storage zone and the at least one workstation for picking and/or repacking articles and forms, in particular, a transport network of transport paths inside the storage and picking system. The transport network is formed by the total of the transport surfaces. Generally, it is also possible here that the transport network is formed by a single transport surface. A movement path always extends on a transport surface and/or along the transport paths in the transport network. A movement path may also include a storage location and/or a storage surface. Transport paths are not necessarily arranged rigidly but can also be formed flexibly or be changed, if required, if (a) mobile conveying device(s) is/are used.

The transport and the storage of the articles inside the storage and picking system can be done with loading aids or without loading aids. A loading aid can, for example, be configured as a container, cardboard box, tray, pallet, hanging bag and suchlike.

On a “belt conveyor,” articles (with or without loading aids) and the mobile measurementvalue acquisition unit are transported standing upright or lying down.

On an “overhead conveyor,” in contrast, articles (with or without loading aids, i.e. with a hanging bag or directly on coat hangers) and the mobile measurement-value acquisition unit are transported in a suspended state.

The stationary, motor-driven conveying means require permanently-integrated devices for transporting articles and may comprise conveyor rollers, conveyor belts, storage-and-retrieval units, overhead conveyors with a drive system, lifts and/or paternosters, and the mobile, motor-driven conveying means may comprise autonomous guided vehicles.

An “autonomous guided vehicle” (“autonomous guided vehicle,” “AGV” in short, or “autonomous mobile robot,” “AMR” in short) is a non-railborne conveying vehicle operated in an automated manner (driverless) for transporting articles and the mobile measurement-value acquisition unit which travels along permanently-specified paths or which is freely guided, i.e. without fixed track guidance. A fixed track guidance can be specified on the floor of the travel surface, for instance with the help of optical color stripes, with magnetic strips or with marker tags. Wheels, at least one of which is driven, are arranged on a chassis of the guided vehicle. At least one of the wheels is steerable, unless the autonomous conveying vehicle has wheels with which also a lateral movement can be executed (e.g. Mecanum wheels). An autonomous guided vehicle also comprises sensors for capturing the environment of the guided vehicle and for spatial orientation. Further, an autonomous guided vehicle also comprises an electronic control for receiving commands from a superordinate (central) control and for controlling/regulating the movements of the autonomous guided vehicle. An autonomous guided vehicle has, in particular, a transport platform on which (an) article(s) to be transported or a mobile measurement-value acquisition unit to be transported lying down/standing upright can be received temporarily. Instead of the transport platform, or in addition to it, the conveying vehicle operated in an automated manner may also have a (telescopable) hanger rod and/or overhead conveyor for receiving hanging bags or a mobile measurement-value acquisition unit to be transported in a suspended state. For example, the transport platform/hanger rod can be permanently affixed to the conveying vehicle, yet the transport platform/hanger rod can also be vertically and/or laterally movable relative to a chassis of the conveying vehicle, for example in order to be able to in-feed (an) article(s) or a mobile measurement-value acquisition unit into a storage rack and out-feed it/them from the storage rack.

A “storage-and-retrieval unit” is a conveying vehicle operated in an automated manner which has similar features as an autonomous guided vehicle but travels on rails. A storage-and-retrieval unit can be configured as a single-level storage-and-retrieval unit (also referred to as “shuttle”) or as a multi-level storage-and-retrieval unit. Such storage-and-retrieval units are moved along travel rails and are therefore railborne. For this reason, storage-and-retrieval units are counted among the stationary conveying device(s).

A “workstation for picking and/or repacking articles” is an area or location in or on which articles can be loaded into or unloaded from a loading aid. In particular, the picking serves the compiling of articles which are included in a sales order. The repacking of articles relates, for example, to the repacking of an incoming-goods unit into a loading aid on the basis of an order which is not identical with the sales order.

A “transport surface” for receiving and for transporting (an) article(s) and/or the mobile measurement-value acquisition unit can have different forms. For example, a transport surface in case of conveyor rollers is formed by a (virtual) plane which tangentially touches the conveyor rollers on their top side. This similarly applies to a conveyor belt, in which the transport surface is formed by the tight side of the conveyor belt. A lift, or a paternoster, comprises a vertically-displaceable platform which forms a transport surface on its top side. Equally, a storage-and-retrieval unit (single-level storage-and-retrieval unit or multi-level storage-and-retrieval unit) comprises a platform which is arranged on a chassis and forms a transport surface on its top side. The chassis itself has rail-guided wheels for its movement. An autonomous guided vehicle equally comprises a platform which is arranged on a chassis and forms a transport surface on its top side. The chassis itself, again, has wheels for its movement. The above-mentioned platforms are moving, as a whole, in relation to a floor of the storage and picking system and are, in particular, configured as rigid bodies. A conveyor belt, in contrast, is not a rigid body, and—in terms of the entire conveyor belt—there is no relative movement in relation to the floor of the storage and picking system. Instead, the transport surface relevant for a movement of (an) article(s) or of the mobile measurement-value acquisition unit is situated (only) on the tight side of the conveyor belt.

The sensors of the mobile measurement-value acquisition unit may comprise a microphone, a vibration sensor or an acceleration sensor (e.g. on the basis of a piezo technology), a temperature sensor, an infrared camera, a camera for the visible wavelength range, a tilt sensor, an RFID transponder (for positioning), sensors for the triangulation, distance measurement or travel-time measurement (e.g. for the positioning by means of indoor GPS, Bluetooth or WLAN) and/or a gas sensor. For positioning, the mobile measurement-value acquisition unit can furthermore have a barcode, if the positioning is done with the help of a barcode reader.

It is further possible that
an acoustic pressure is provided as a physical parameter, and a measured loudness value or an audio recording (and therefore a temporal development of the acoustic pressure) is acquired by a sensor,
an amplitude or a frequency of a mechanical vibration is provided as a physical parameter, and a measurement value for the amplitude and/or the frequency of the vibration is acquired by a sensor, p0 a temperature is provided as a physical parameter, and a measured temperature value or an infrared image (and thus a local distribution of the temperature) is acquired by a sensor, a brightness and/or a color is provided as a physical parameter, and a still image (local distribution of brightness and/or color) or a moving video recording (temporal development of the local distribution of brightness and/or color) is acquired by a sensor,
a concentration of a gas (in particular of oxygen) is provided as a physical parameter, and a gas concentration is acquired by a sensor and/or
a time span is provided as a physical parameter, and the time span is ascertained by a time measuring device which the mobile measurement-value acquisition unit requires for a movement from a first location to a second location.

In the broadest sense, therefore, also a counter module which captures the oscillations of an oscillator circuit and converts them into a time can be understood as a “sensor” within the scope of the invention.

Further advantageous designs and further advancements of the invention result from the subclaims as well as from the description in combination with the figures.

It is favorable if the mobile measurement-value acquisition unit has a transport base with whose help the mobile measurement-value acquisition unit is transportable standing upright or lying down on the transport surface of the conveying means of the storage and picking system. Accordingly, the mobile measurement-value acquisition unit is transported standing upright or lying down on the transport surface of the conveying means of the storage and picking system. This embodiment is especially suited for storage and picking systems in which articles and/or loading aids are transported standing upright or lying down.

It is further favorable if the mobile measurement-value acquisition unit has a suspended transport carrier with whose help the mobile measurement-value acquisition unit is transportable standing upright or lying down on the transport surface of the conveying means of the storage and picking system. Accordingly, the mobile measurement-value acquisition unit is transported in a suspended state on the transport surface of the conveying means of the storage and picking system. This embodiment is especially suited for storage and picking systems in which articles and/or loading aids are transported in a suspended state. In particular, the conveying means of the storage and picking system form overhead conveyors, in this case. The suspended transport carrier may comprise, for example, a hook and/or a carriage, or be formed by same.

It is further advantageous if the mobile measurement-value acquisition unit is transported alternately standing upright/lying down and in a suspended state on the transport surface of the conveying means of the storage and picking system. This embodiment is especially suited for storage and picking systems in which articles are transported (with or without loading aids) both standing upright/lying down and in a suspended state.

It is particularly advantageous if an exterior housing of the mobile measurement-value acquisition unit is identical, in form and/or size, with a loading aid which serves the transport of articles and the storage of articles in the storage and picking system. In this way, the mobile measurement-value acquisition unit can be transported and deposited, or suspended, on a storage location in the storage and picking system in exactly the same way as a loading aid. The mobile measurement-value acquisition unit may, in particular, be designed as a modular system which can be integrated into different kinds of loading aids. For example, at least the autarkic power supply, the central processing unit and the sensors of the mobile measurement-value acquisition unit can be constructed on a base plate, or built into a base housing. The base plate, or the base housing, can then be built into a loading aid, for example by strutting the base plate, or the base housing, in the loading aid or by sticking, foaming or screwing the base plate, or the base housing, into the loading aid. In this case, the loading aid comprises the transport base, or the suspended transport carrier, of the mobile measurement-value acquisition unit. The mobile measurement-value acquisition unit may therefore also comprise a loading aid (for example a container or a hanging bag) and be buffered temporarily and/or stored either lying down on the storage surface (container) or suspended on the storage surface.

Particularly advantageous is a variant of the method presented in which at least one measurement value, at least one temporal development of at least one measurement value and/or at least one local distribution of measurement values of a physical parameter, or of multiple physical parameters, are subjected to an analysis for detecting an anomaly, in terms of a deviation from a normal state, and/or an irregularity. This enables pre-existing, or imminent, problems in the storage and picking system to be identified. Accordingly, it is also of advantage if the storage and picking system has a computer-aided evaluation unit which is configured for subjecting at least one measurement value, at least one temporal development of at least one measurement value and/or at least one local distribution of measurement values of a physical parameter, or of multiple physical parameters, to an analysis for detecting an anomaly, in terms of a deviation from a normal state.

It is further particularly advantageous if the method presented is configured for detecting an anomaly in a storage and picking system and additionally comprises the following steps:
acquiring a measurement value, a temporal development of a measurement value and/or a local distribution of measurement values of the physical parameter acquired at the first point in time along the movement path with the help of the sensors on essentially the same location at a second point in time,
ascertaining a deviation of the measurement value acquired at the first point in time from the measurement value acquired at the second point in time, of the temporal development of the measurement value acquired at the first point in time from the temporal development of the measurement value acquired at the second point in time and/or of the local distribution of the measurement values acquired at the first point in time from the local distribution of the measurement values acquired at the second point in time, and generating and issuing a deviation notice if the ascertained deviation exceeds a specifiable threshold.

Accordingly, it is also of advantage if the computer-aided evaluation unit
is configured for acquiring a measurement value, a temporal development of a measurement value and/or a local distribution of measurement values of this physical parameter along the movement path with the help of the sensors on a location in the storage and picking system at a first point in time,
is configured for acquiring a measurement value, a temporal development of a measurement value and/or a local distribution of measurement values of this physical parameter along the movement path with the help of the sensors on essentially the same location at a second point in time,
is configured for ascertaining a deviation of the measurement value acquired at the first point in time from the measurement value acquired at the second point in time, of the temporal development of the measurement value acquired at the first point in time from the temporal development of the measurement value acquired at the second point in time and/or of the local distribution of the measurement values acquired at the first point in time from the local distribution of the measurement values acquired at the second point in time, and
is configured for generating and issuing a deviation notice if the ascertained deviation exceeds a specifiable threshold.

It is further particularly advantageous if at least one measurement value, a temporal development of at least one measurement value and/or at least one local distribution of measurement values of a physical parameter, or of multiple physical parameters, are subjected to an analy sis for automatic detection of an anomaly using a statistical signal evaluation, or using a learning algorithm, and a deviation notice is generated and issued if an anomaly, in terms of a deviation from a normal state, has been identified. Accordingly, it is of advantage if the computer-aided evaluation unit is configured for subjecting at least one measurement value, at least one temporal development of at least one measurement value and/or at least one local distribution of measurement values of a physical parameter, or of multiple physical parameters, to an analysis for automatic detection of an anomaly using a statistical signal evaluation, or using a learning algorithm, and for generating and issuing a deviation notice if an anomaly, in terms of a deviation from a normal state, has been identified.

For example, slow changes in a time series of measurement values (“measurement-value drifts”) may be an indication of an imminent problem in the storage and picking system. But also rapid and strong variations in measurement values are often indicators of a (in particular pre-existing) problem in the storage and picking system. The statistical signal evaluation is especially suited for the analysis of measurement series of individual physical parameters, whereas learning algorithms (e.g. artificial neuronal networks, self-learning decision trees, genetic algorithms) are of advantage especially for the analysis of measurement series of a plurality of physical parameters. The application of learning algorithms is also known by the term “machine learning.” It should be noted in this context that said methods are suited not only for identifying negative developments, and then problems, but that also positive developments can generally be identified. These may equally contribute to improving a storage and picking system, by taking these positive effects into account and boosting them during the planning and operation.

Within the scope of this disclosure, the term “deviation notice” is to be construed broadly and comprises, in particular, acoustic and/or optical signals, as well as notifications to connected receiving devices. A deviation notice can therefore, in particular, also be understood to mean an e-mail, an SMS (“short message service”), the setting of a flag or the issuing of an interruption signal. In terms of substance, the deviation notice may comprise the ascertained deviation itself (i.e., for example, the difference between two measurement values), or also the mere information that there is a deviation (in the sense of a distinction: deviation/no deviation). If an imminent, or even an existing, fault in the storage and picking system can be assigned to the ascertained deviation, the deviation notice may also have and/or assume the function of an alarm.

Further, it is particularly advantageous if an input prompt is addressed to a user at the same time as the deviation notice is issued, and a piece of technical information of the user relating to an operating ability of the storage and picking system is acquired at an input device, and the piece of technical information is assigned to the deviation and stored in the database, or the piece of technical information is fed into an algorithm together with the deviation. Accordingly, it is of advantage if the computer-aided evaluation unit is configured for addressing an input prompt to a user at the same time as the deviation notice is issued and for acquiring a piece of technical information of the user relating to an operating ability of the storage and picking system at an input device and for assigning the piece of technical information to the deviation and storing it in the database, or for feeding the piece of technical information into an algorithm together with the deviation.

There is, therefore, a classification of said deviation, wherein the experience of the plant operator enters into the classification. Over time, a knowledge base can thus be compiled which helps to be able to swiftly and correctly assign future anomalies to a piece of technical information. In particular, together with the acquisition of the piece of technical information, also a location or component assigned to the piece of technical information can be input, e.g. “defective bearing on conveyor roller number 7.”

It is furthermore particularly advantageous if a piece of technical information relating to an operating ability of the storage and picking system is assigned to a deviation, or multiple deviations, in a database and/or by means of an algorithm, and this piece of technical information is issued as a deviation notice, or together with the deviation notice (via an output unit). There is, therefore, equally a classification of said deviation. In other words, the storage and picking system has a database and/or an algorithm which is configured for ascertaining an assignment of a piece of technical information relating to an operating ability of the storage and picking system to a deviation of the measurement value acquired at the first point in time from the measurement value acquired at the second point in time, of the temporal development of the measurement value acquired at the first point in time from the temporal development of the measurement value acquired at the second point in time and/or of the local distribution of the measurement values acquired at the first point in time from the local distribution of the measurement values acquired at the second point in time. The output unit can be adapted, for example, for optical and/or acoustic output.

The above-mentioned assignment is stored in the database and can be read out when this assignment is required. In contrast to this, in case the help of an algorithm is used, the above-mentioned assignment is done by computation. The algorithm may comprise a mathematical model of the storage and picking system, or a neuronal network, or be formed by same. Said piece of technical information relating to an operating ability of the storage and picking system may comprise, for example, an indication of measurement values in the normal range, an indication of wear and tear, an indication of an imminent technical defect or an indication of an existing technical defect, or be formed by same. In this embodiment, the method presented thus comprises the function of an expert system.

It is favorable if
an excessive temperature rise in the area of a roller or slide bearing (e.g. in the periph ery of a conveyor roller) is assigned a defective bearing as a piece of technical information,
a noise which is characteristic of a defective bearing is assigned a defective bearing as a piece of technical information,
an excessive temperature rise in the area of an electronic circuit is assigned an electric defect as a piece of technical information,
an excessive temperature rise in the area of a drive motor is assigned a defective motor as a piece of technical information,
an excessive vibration is assigned an undone or loosened screw connection as a piece of technical information,
an (optically captured) displacement of a screw head or a nut is assigned an undone or loosened screw connection as a piece of technical information and/or
a below-average movement speed is assigned excessive slip on the conveying means (e.g. oiled-up conveyor roller) as a piece of technical information.

In the above list, “defective” is to be understood to mean both an imminent and a pre-existing defect. In particular, an imminent defect is assigned different threshold values of an detected deviation of measured data, or of an detected anomaly, than a pre-existing defect. In particular, also a below-average movement speed is qualified as an anomaly, or even defect.

Further, it is advantageous if the piece of technical information and the deviation are fed into a learning algorithm and if the learning algorithm computes a correlation between the piece of technical information and the deviation, or multiple deviations, or a probability of the correctness of the assignment of the piece of technical information to the deviation, or multiple deviations, for a plurality of deviations. Humans may find the assignment of a piece of technical information to a specific class of deviations difficult, for the deviations assigned to a piece of technical information are not necessarily identical but may vary, sometimes considerably. Learning algorithms are particularly suited to detect correlations between technical information and deviations, even if certain coherences are not, a priori, apparent to humans. This is true, in particular, in case of a correlation of multiple physical parameters to a piece of technical information. Over time, a knowledge base can thus be compiled and improved which helps to be able to swiftly and correctly assign future anomalies to a piece of technical information.

A “learning algorithm” generates knowledge from experience and, to that end, learns on the basis of examples and, after concluding the learning phase, is able to generalize these. During the learning phase, the learning algorithm builds a statistical model which is based on training data. Examples of learning algorithms are, for example, artificial neuronal networks, self-learning decision trees, as well as genetic algorithms The procedure described is also known by the term “machine learning.” Within the scope of the invention, the learning or training phase can be done, in particular in full or in part, during operation of the storage and picking system.

It is also advantageous if a probability of the correctness of the piece of technical information is issued together with this piece of technical information and/or the piece of technical information is issued only if the probability of the correctness of the information exceeds a threshold value, i.e. if same is reliable. In this way, it is avoided that the operator of the storage and picking system is mislead by a piece of technical information which is not confirmed, and misinterprets the reported symptom. For example, an issuing may be “probably defective bearing” or “defective bearing with a probability of 75%.” It is also conceivable that the issuing below a value of 10% probability, for example, is suppressed.

It is further advantageous if mobile measurement-value acquisition units of multiple storage and picking systems use the same database and/or the same algorithm. In this way, the knowledge regarding the anomalies and defects occurring in multiple storage and picking systems can be pooled in one place, whereby the above-mentioned algorithm, the above-mentioned model and also the operating personnel of a storage and picking system can benefit from the knowledge accumulated in another storage and picking system. Overall, this reduces the maintenance requirements for a plurality of storage and picking systems. In particular, there is also the possibility of a central monitoring point for a plurality of storage and picking systems, whereby the knowledge regarding the anomalies and defects occurring in multiple storage and picking systems is pooled on one location, also in terms of personnel. This further reduces the maintenance requirements for a plurality of storage and picking systems. “The same database” or “the same algorithm” may also comprise multiple identical instances of the database or of the algorithm (or its data pool) or at least identical parts of multiple different databases or algorithms (or their data pools). The latter means that the terms may also refer to a shared intersection of databases or algorithms Data relating to the method disclosed can also be parts of a “data lake” and/or be stored in same.

In another advantageous embodiment of the storage and picking system, same comprises a remote control which
is configured for receiving (in particular in real time) a measurement value, a temporal development of a measurement value and/or a local distribution of measurement values of a physical parameter and
is configured for transmitting (in particular in real time) control commands to the mobile measurement-value acquisition unit, as well as to the conveying means of the storage and picking system by means of which the mobile measurement-value acquisition unit is moved. Accordingly, a measurement value, a temporal development of a measurement value and/or a local distribution of measurement values of a physical parameter are advantageously transmitted (in particular in real time) to a remote control and/or to an operator, and the mobile measurement-value acquisition unit, as well as the conveying means of the storage and picking system by means of which the mobile measurement-value acquisition unit is moved, receive control commands by this remote control and/or by this operator and execute same (in particular in real time).

In particular, the remote control is also connected to a superordinate central control system of the storage and picking system (e.g. with a material flow computer or a warehouse management system) in order to be able to prompt a targeted movement of the conveying means of the storage and picking system. Here, the measured data can be transferred to the remote control in real time, or the measured data are stored temporarily and transferred to the control at a later point in time. Equally, the movement path and/or route on which the mobile measurement-value acquisition unit is to be moved through the storage and picking system can be specified, or preprogrammed, in real time. In particular, also the mere specification of waypoints which the mobile measurement-value acquisition unit is to pass is possible, wherein the specific implementation, i.e. the determination of a movement path and/or route which contains these waypoints, is left up to the superordinate central control system of the storage and picking system and/or is done by same.

It is further favorable if the storage and picking system has a charging station for an autarkic power supply (e.g. an accumulator) of the mobile measurement-value acquisition unit. In this way, an empty accumulator of the mobile measurement-value acquisition unit can be recharged. In particular, the charging station may be situated on a storage location in the storage zone.

It is furthermore favorable if the mobile measurement-value acquisition unit can be switched to a display mode in which it is stopped, by the conveying means of the storage and picking system, on the location on which an anomaly or a deviation above the specified threshold has been detected and issues an optical and/or acoustic signal there. In this way, the location of an detected anomaly, or of an detected defect, can be displayed in the storage and picking system in a simple manner A reading of site plans and circuit diagrams for locating the above-mentioned location will therefore be obsolete. The work of operating and maintenance personnel will therefore be simplified considerably. The issuing of the above-mentioned optical and/or acoustic signal does not exclude the issuing of additional signals, for example in the form of text messages. For example, an operator may receive information on the location of an detected anomaly, or of an detected defect, in written form, in the form of a site plan or in the form of directions (in the sense of a navigation system).

Further, it is of advantage if the mobile measurement-value acquisition unit, or a repair unit, can be switched to a repair mode in which it transports, with the help of the conveying means of the storage and picking system, spare parts and/or aids which serve to correct an detected defect to the location on which the defect has been detected. Like the mobile measurement-value acquisition unit, the repair unit is configured for a transport on the transport surface of the motor-driven conveying means of the storage and picking system along the movement path and/or for an intermediate stop on the storage surface of the storage locations of the storage and picking system, which storage surface is situated on the movement path. In particular, the repair unit may also comprise a loading aid described above, for example a container. The proposed measures ensure that the workload on operating and maintenance personnel is reduced considerably, as the spare parts, aids and tools required for a correction of an detected defect are transported, with the help of the conveying means, to the location on which the defect has been detected. The advantage of the embodiment presented will therefore become apparent, in particular, whenever the location on which a defect is to be corrected is difficult to access. It should also be noted in this context that the proposed measures can also be applied independent of the features of the independent claims. The repair unit may thus form the basis for an independent divisional application. In the given context, it is advantageous if the mobile measurement-value acquisition unit, or the repair unit, in the repair mode issues an optical and/or acoustic signal on the location on which the defect has been detected. The advantages disclosed in this respect in the preceding paragraph apply analogously in this case.

It is further favorable if the acquisition of a measurement value, of a temporal development of a measurement value and/or of a local distribution of measurement values of a physical parameter is done during operation of the storage and picking system by transporting articles and the mobile measurement-value acquisition unit simultaneously in the storage and picking system. This means that the acquisition of measured data is done during operation of the storage and picking system, and therefore the performance of same is not limited by the acquisition of the measured data.

Yet it is also favorable if the acquisition of a measurement value, of a temporal development of a measurement value and/or of a local distribution of measurement values of a physical parameter is done in an analysis mode of the storage and picking system by moving the mobile measurement-value acquisition unit alone in the storage and picking system. In this way, disruptive influences during the acquisition of measured data can be reduced and/or minimized For example, the acquisition of audio data is influenced by background noise only to a small degree. For example, the acquisition of measured data can be done during night time.

Said advantages also apply to the partial shut-down of the storage and picking system, of course, i.e. when the mobile measurement-value acquisition unit moves alone in a sub-area of the storage and picking system.

It is further advantageous if
a disruption, or a defect, in the storage and picking system is detected, and the location of the disruption, or of the defect, is ascertained,
the mobile measurement-value acquisition unit is transported to said location and
a measurement value, a temporal development of a measurement value and/or a local distribution of measurement values of a physical parameter is acquired on said location.

The disruption, or the defect, in this embodiment, is not necessarily detected by the mobile measurement-value acquisition unit but can be detected with the help of another sensor system provided (in particular installed so as to be stationary) in the storage and picking system. It would also be possible that the disruption, or the defect, is detected by a mobile measurement-value acquisition unit other than the one moved to the location of the disruption, or of the defect. The measurement-value acquisition unit transported to the location of the disruption, or of the defect, can be used to acquire additional data relating to the disruption, or to the defect. For example, infrared recordings, video recordings or audio recordings of the location for which a disruption, or a defect, has been ascertained can be made. In this way, the disruption, or the defect, can be characterized in more detail, even if a stationary sensor system is unable to do this. The transport of the mobile measurement-value acquisition unit to the location of the disruption, or of the defect, as well as the acquisition of measured data, can be triggered and/or controlled by a central control of the storage and picking system. In particular, also the remote control disclosed further above can be used for said purposes.

Further, it is also of advantage if personal data are deleted, or rendered unrecognizable, in an audio recording and/or in a recording of a still, or moving, image. This ensures the protection of personal data, for example if a conversation between individuals is inadvertently recorded.

Further, it is also of advantage if the locating of the mobile measurement-value acquisition unit is done with the help of the central control system, or by the mobile measurement-value acquisition unit itself. If the locating of the mobile measurement-value acquisition unit is done with the help of the central control system, this may be done in the same way as the locating of the articles, of the lying article loading aids and of the hanging bags. For example, the locating of the mobile measurement-value acquisition unit can therefore be done with the help of route signals of the moving transport surface (e.g. with the help of route markings on a conveyor belt which are evaluated via an optical or magnetic sensor), or also with rotation signals which are ascertained in motor drives of the conveying means (e.g. via a hall effect sensor of a brushless DC motor, via the control signals for a drive motor or also via a rotary encoder in the drive motor, or in the drivetrain). For example, the rotation signals can be used to compute route signals, in turn, on the basis of the circumference of a rotating conveyor roller of a conveying means. Alternatively, or additionally, also light barriers, cameras, barcode readers and/or RFID readers which are arranged along the conveying device(s) can be used for locating the mobile measurement-value acquisition unit. In this case, stationary light barriers, cameras, barcode readers and RFID readers serve predominantly the determination of the absolute position of the mobile measurement-value acquisition unit, whereas route and rotation signals serve the determination of the relative position of the mobile measurement-value acquisition unit on the basis of a reference location. The reference location may in particular be a stationary light barrier, or camera, or a stationary barcode reader, or RFID reader.

Yet the locating of the mobile measurement-value acquisition unit can also be done, for example, by triangulation, distance measurement or travel-time measurement, for instance with the help of indoor GPS (Global Positioning System), Bluetooth or WLAN (wireless local area network). For example, the position of the mobile measurement-value acquisition unit is determined by measuring the distance to reference points whose position is known, by measuring the travel time of a (radio) signal between the mobile measurement-value acquisition unit and such reference points and/or by measuring an angle to such reference points. The travel time of a signal can, in turn, be used to compute the distance to this reference point, as the signal speed is known. In particular, the reference point can be formed by a transmitting and/or receiving station for a (radio) signal and, in particular, work according to the standard or GPS, Bluetooth or WLAN. It should be noted in this context that the locating of the mobile measurement-value acquisition unit on the basis of triangulation, distance measurement or travel-time measurement can be done by the mobile measurement-value acquisition unit itself, or also by the central control system, which is in communication with the transmitting and/or receiving station mentioned above. It is further conceivable that the locating of the mobile measurement-value acquisition unit is done by displacement measurement on the basis of a reference point with the help of a displacement sensor integrated into the mobile measurement-value acquisition unit. For example, a capacitive, inductive or optical sensor (in particular a camera) which is pointed at stationary parts of the conveying device(s), or of the storage zone, can be used to that end. For example, the distance traveled can be ascertained by optical processing of images recorded using a camera. Also sensors in the manner of optical sensors, such as they are used, for example, in computer mice, can be used for the displacement measurement. It would further also be conceivable to count the conveyor rollers past which the mobile measurement-value acquisition unit has been moved, for example optically or inductively. An acceleration sensor can be used, for example, to ascertain curvatures of the track (e.g. bends, switches, slopes, etc.). Yet a displacement measurement would generally also be possible with the acceleration sensor if the sensor signal is time-integrated accordingly.

It is also advantageous if a map of the storage and picking system is made with the help of the positions ascertained for the measurement-value acquisition unit, and the ascertained measurement values (in accordance with a local distribution of measurement values), a deviation of the measurement value acquired at the first point in time from the measurement value acquired at the second point in time (in accordance with a local distribution of deviations), a deviation notice, a piece of technical information, a disruption and/or a defect are marked on the map. In this way, the specified data can easily be depicted in graphic form. Advantageously, the data for the map required for this purpose are ascertained by the mobile measurement-value acquisition unit itself. Yet also design data of the storage and picking system (e.g. CAD data) can generally be used for the making of a map. Yet these data are often not available, or are not representative of reality. These problems are overcome by taking the measurements of the storage and picking system using the mobile measurement-value acquisition unit. For this purpose, the mobile measurement-value acquisition unit may also comprise a laser scanner. Generally, it is also of advantage if additional information can be marked on the map of the storage and picking system. For example, parts of the plant can be designated on the map, e.g.

as “conveying path number 1,” and so on.

It is finally also of advantage if the map of the storage and picking system ascertained using the measurement-value acquisition unit is matched against design data of the storage and picking system (e.g. against CAD data). In this way, the map of the storage and picking system ascertained by the measurement-value acquisition unit is harmonized (as much as possible) with design data of same. In this way, measurement errors during the acquisition of the position of the mobile measurement-value acquisition unit on which the map is based can be corrected, for example.

It should be noted in this context that the variants and advantages disclosed in relation to the storage and order-picking system presented equally relate to the method presented, and vice versa.

For the purpose of better understanding of the invention, it will be elucidated in more detail by means of the figures below.

These show in a respectively very simplified schematic representation:

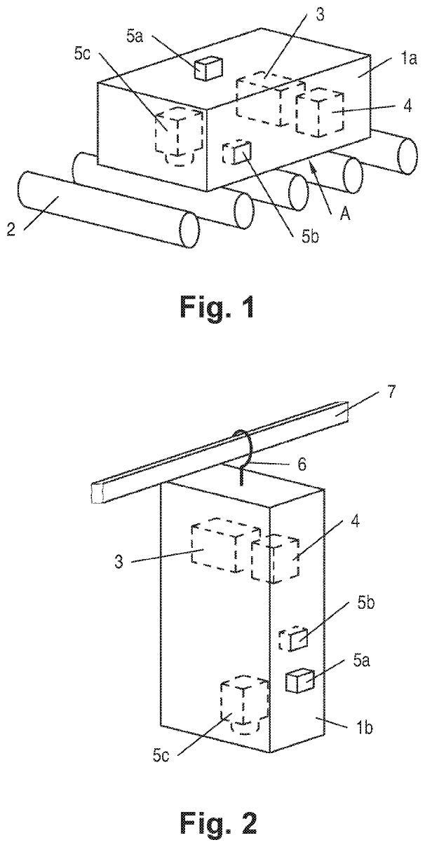

FIG. 1 an exemplary mobile measurement-value acquisition unit which is moved standing upright and/or lying down on conveyor rollers, in an oblique view;

FIG. 2 an exemplary mobile measurement-value acquisition unit which is moved in a suspended state on an overhead conveyor, in an oblique view;

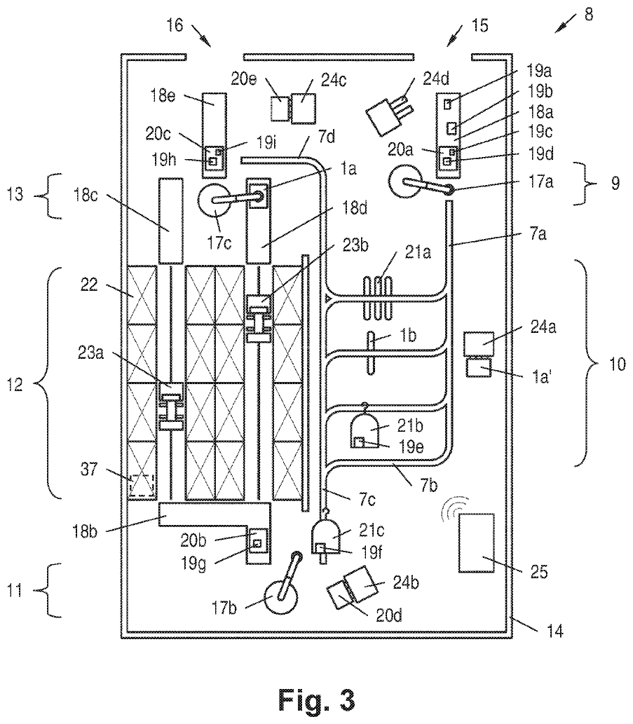

FIG. 3 an exemplary and schematically depicted storage and picking system in a top view;

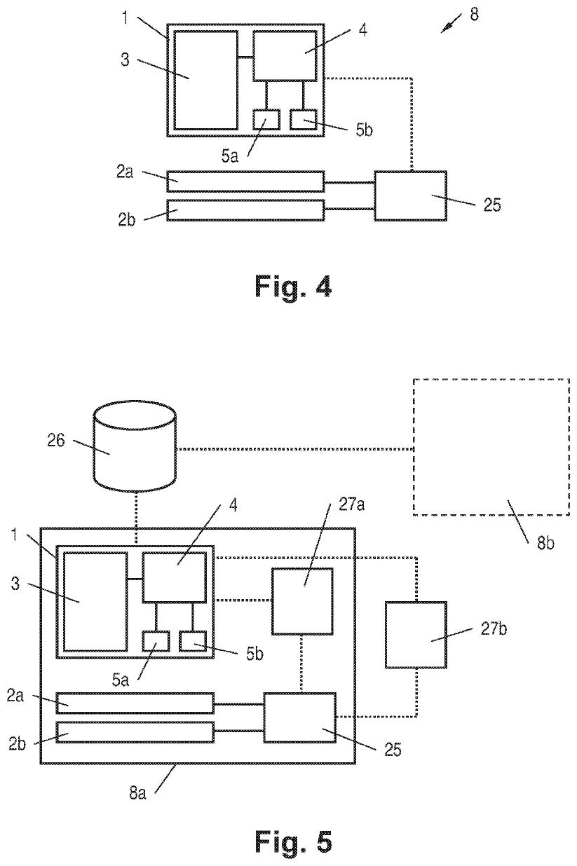

FIG. 4 a functional diagram of an exemplary storage and picking system having a mobile measurement-value acquisition unit;

FIG. 5 similar to FIG. 4 but with a remote control for the mobile measurement-value acquisition unit and a central database;

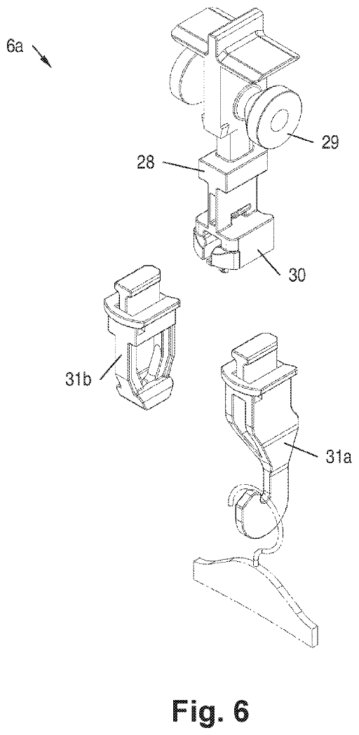

FIG. 6 examples of a suspended transport carrier in an oblique view and

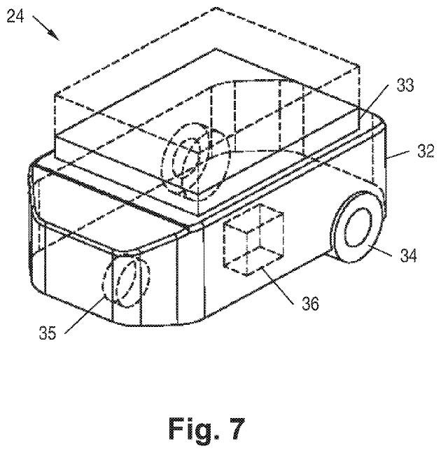

FIG. 7 an example of an autonomous guided vehicle in an oblique view.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, are to be analogously transferred to the new position.

FIG. 1 shows an exemplary mobile measurement-value acquisition unit 1a which is moved standing upright and/or lying down on conveyor rollers 2, in an oblique view. In this example, the mobile measurement-value acquisition unit 1a comprises an autarkic power supply 3, a central processing unit 4 and multiple sensors 5a . . . 5c.

The central processing unit 4 may, in particular, comprise a microcontroller, an industrial computer (in particular in combination with a database) or a programmable logic controller, “PLC” in short, or be formed by same.

The conveyor rollers 2 form a variant embodiment of motor-driven conveying means of (a) conveying device(s) which is configured for transporting articles and the mobile measurement-value acquisition unit 1a inside a storage and picking system. A transport surface for the articles and the mobile measurement-value acquisition unit 1a is formed by a (virtual) plane which tangentially touches the conveyor rollers 2 on their top side.

Conversely, the mobile measurement-value acquisition unit 1a has a transport base A with whose help the mobile measurement-value acquisition unit 1a can be transported standing upright or lying down on the transport surface of the conveyor rollers 2. The conveyor rollers 2, therefore, also form a belt conveyor. In FIG. 1, the transport base A of the mobile measurement-value acquisition unit 1a and the transport surface of the conveyor rollers 2 are congruent.

In the example shown, the sensor 5a is arranged on the exterior of the housing of the mobile measurement-value acquisition unit 1a and configured as a temperature sensor, for example.

In the example shown, the sensor 5b is situated on the interior of the mobile measurement value acquisition unit 1a and is configured as a vibration sensor/acceleration sensor, for example (e.g. on the basis of a piezo technology). The sensor 5c is finally configured as a camera for the visible wavelength range and/or the infrared range and is pointed downward, in this example. A different alignment of the camera 5c is possible, of course. It is also conceivable that the camera 5c can be motor-pivoted. The mobile measurement-value acquisition unit 1a can, therefore, also have motors and actors, yet it preferably has no motor drive for moving the mobile measurement-value acquisition unit 1a, such as this is the case in FIG. 1.

The above-mentioned types of sensors are mere examples, and the mobile measurement-value acquisition unit 1a could, alternatively or additionally, also have a microphone, a tilt sensor, an RFID transponder, sensors for the triangulation, distance measurement or travel-time measurement (e.g. for the positioning by means of indoor GPS, Bluetooth or WLAN) and/or a gas sensor. The RFID transponder can in particular be used for positioning the mobile measurement-value acquisition unit 1a if the position of RFID readers in the storage and picking system which the mobile measurement-value acquisition unit 1a passes is known.

FIG. 2 shows another example of a mobile measurement-value acquisition unit 1b which is very similar to the mobile measurement-value acquisition unit 1a disclosed in FIG. 1. Yet in contrast to this, the mobile measurement-value acquisition unit 1b has a suspended transport carrier 6 with whose help the mobile measurement-value acquisition unit 1b is transported in a suspended state on an overhead conveyor 7 of a storage and picking system.

The overhead conveyor 7 forms another variant embodiment of a motor-driven conveying means of (a) conveying device(s) which is configured for transporting articles and the mobile measurement-value acquisition unit 1b inside a storage and picking system. A transport surface for the articles and the mobile measurement-value acquisition unit 1b is formed, in this example, by the top side of the overhead conveyor 7. The suspended transport carriers 6 can be moved by means of a frictional drive and/or a form-fit drive. For example, an endlessly revolving traction means, such as a belt or a chain, may be provided for the transport of the articles and of the mobile measurement-value acquisition unit 1b inside a storage and picking system. Such an overhead conveyor 7 and various drive systems are described, for example, in the Austrian patent application A 2019/50092.

In this example, the suspended transport carrier 6 is configured as a hook, yet it could also comprise a carriage, or be formed by same (see also FIG. 6).

Further conceivable is a combination of the embodiments depicted in FIG. 1 and FIG. 2. For example, the mobile measurement-value acquisition unit 1b disclosed in FIG. 2 could also be transported standing upright and/or lying down on the conveyor rollers 2a of FIG. 1. In other words, a mobile measurement-value acquisition unit 1a, 1b can be transported alternately standing upright/lying down and in a suspended state on the transport surface of the conveying means 2, 7 of the storage and picking system.

FIG. 3 shows a schematic depiction of an exemplary storage and picking system 8 in a top view.

Specifically, a first loading station 9, a hanging-bag/hanging-article store 10, a second loading station 11, a lying article store 12 and a picking station 13 are housed in a building 14. According to this embodiment, the first loading station 9 and/or second loading station 11 forms, in particular, a workstation for repacking. According to this embodiment, the picking station 13 forms, in particular, a workstation for picking. In addition, the building 14 has two building openings 15 and 16 which can function as goods-in point and/or goods-out point.

The first loading station 9 may comprise a first robot 17a, a first supply position on a belt conveyor 18a and a second supply position on an overhead conveyor 7a. Multiple articles 19a . . . 19d are arranged on the belt conveyor 18a by way of example. Here, the articles 19c and 19d are lying in a lying article loading aid 20a, the articles 19a and 19b are lying loose (i.e. without a lying article loading aid 20a) on the belt conveyor 18a. The belt conveyor 18a leads from the building opening 15 to the first robot 17a, and the overhead conveyor 7a leads from the first robot 17a to the hanging-bag/hanging-article store 10.

The hanging-bag/hanging-article store 10 comprises multiple overhead conveyors 7b which, for the most part, serve storage purposes and on which some hanging bags 21a, 21b, as well as a mobile measurement-value acquisition unit 1b, are depicted by way of example. Here, the hanging bag 21b is drawn rotated by 90° in order to be able to depict the article(s) 19e stored therein. In reality, the hanging bag 21b hangs downward like the hanging bags 21a, of course. An overhead conveyor 7c leads from the hanging-bag/hanging-article store 10 to the second loading station 11. The second loading station 11 may comprise a second robot 17b, a first supply position on the overhead conveyor 7c and a second supply position on a belt conveyor 18b, wherein the latter leads from the second robot 17b of the second loading station 11 to the lying article store 12.

In the example shown, there is a hanging bag 21c with (an) article(s) 19f stored therein at the first supply position of the second loading station 11. Like the hanging bag 21b, the hanging bag 21c is drawn rotated into the plane of projection for the sake of better depictability. In the example shown, there is a lying article loading aid 20b with (an) article(s) 19g stored therein at the second supply position of the second loading station 11.

In this example, the article store 12 comprises multiple storage racks 22 with multiple storage locations each, as well as storage-and-retrieval units 23a and 23b which travel in rack aisles extending between the storage racks 22. Two belt conveyors 18c, 18d which lead from the article store 12 to the picking station 13 are arranged at the top end of the rack aisles.

The picking station 13 may comprise a third robot 17c, a first supply position on the belt conveyor 18c, a second supply position on the belt conveyor 18d and a third supply position on a belt conveyor 18e, wherein the latter connects the third robot 17c with the building opening 16.

Further, also an overhead conveyor 7d which connects the hanging-bag/hanging-article store 10 with the picking station 13 is depicted in FIG. 3.

In this example, a mobile measurement-value acquisition unit 1a is situated at the second supply position on the belt conveyor 18d, and a lying article loading aid 20c with two articles 19h, 19i stored therein is situated at the third supply position on the belt conveyor 18e.

The storage and picking system 8 depicted in FIG. 3 may also comprise an autonomous guided vehicle 24a . . . 24d, or multiple autonomous guided vehicles 24a . . . 24d, with a mobile measurement-value acquisition unit 1a′ transported thereupon and lying article loading aids 20d, 20e transported thereupon. Here, the autonomous guided vehicles 24a and 24b are specifically situated between the first loading station 9 and the second loading station 11, and the autonomous guided vehicles 24c and 24d are situated between the first loading station 9 and the picking station 13.

Additionally or alternatively to the depicted hanging bags 21a . . . 21c, also hanging articies (without hanging bags) can be transported on the overhead conveyors 7a . . . 7d of the storage and picking system 8 depicted in FIG. 3.

Finally, FIG. 3 shows an optional charging station 37 for an autarkic power supply (e.g. an accumulator) of the mobile measurement-value acquisition unit 1a, 1a′, 1b. In this way, an empty accumulator of the mobile measurement-value acquisition unit can be recharged. Specifically, the charging station 37 is situated on a storage location in the storage zone 12, yet it could also be situated elsewhere, for example at the conveying device(s).

The functioning of the storage and picking system 8 depicted in FIG. 3 is as follows: Articles 19a . . . 19i can be delivered via the building openings 15 and 16 and in-fed in the hanging-bag/hanging-article store 10, or in the lying article store 12. Yet articles 19a . . . 19i may also be out-fed from the hanging-bag/hanging-article store 10, or from the lying article store 12, and transported away via the building openings 15 and 16.

Here, the belt conveyors 18a . . . 18e, the overhead conveyors 7a . . . 7d, the storage-and-retrieval units 23a, 23b and the autonomous guided vehicles 24a . . . 24d, if provided, serve the transport of the articles 19a . . . 19i inside the storage and picking system 8. The robots 17a . . . 17c serve the reloading of articles 19a . . . 19i between the various belt conveyors 18a . . . 18e and overhead conveyors 7a . . . 7d. The processes in the storage and picking system 8 are elucidated in more detail by means of an illustrative example.

For example, articles 19a . . . 19d can be provisioned at the building opening 15 of the storage and picking system 8, dispensed onto the belt conveyor 18a and supplied at the first supply position of the first loading station 9. An (empty) hanging bag 21a . . . 21c is supplied at the second supply position of the first loading station 9. The articles 19a . . . 19d are then picked off the belt conveyor 18a, or off the lying article loading aid 20a, by the first robot 17a and loaded into the hanging bag 21a . . . 21c supplied. The loaded hanging bags 21a . . . 21c are then transported into the hanging-bag/hanging-article store 10.

In another step, the articles 19a . . . 19d contained in the hanging bags 21a . . . 21c are reloaded by the second robot 17b of the second loading station 11 from the hanging bags 21a . . . 21c into a lying article loading aid 20b. To that end, a loaded hanging bag 21a . . . 21c is supplied at the first supply position of the second loading station 11, and a lying article loading aid 20b is supplied at the second supply position of the second loading station 11. Subsequently, the lying article loading aid 20b with the reloaded articles 19a . . . 19d is in-fed into the lying article store 12. To that end, the lying article loading aid 20b is transported by the belt conveyor 18b to one of the two storage-and-retrieval units 23a, 23b, taken over by same and in-fed into the storage rack 22.

When an order for picking articles 19a . . . 19d is acquired, a lying article loading aid 20b which contains the articles 19a . . . 19d assigned to the picking order is out-fed from the storage rack 22 using one of the two storage-and-retrieval units 23a, 23b and handed over onto the respective belt conveyors 18c, 18d. The article(s) 19a . . . 19d is/are transported to the first, or second, supply position of the picking station 13 with the help of the belt conveyors 18c, 18d and supplied there. A lying article loading aid 20c is supplied at the third supply position of the picking station 13. Then, the articles 19a . . . 19d assigned to the picking order are loaded from the lying article loading aid 20b into the lying article loading aid 20c by the third robot 17c. Of course, it is also conceivable that (an) article(s) 19a . . . 19d originating from the hanging-bag/hanging-article store 10 is/are transported to the picking station 13 via the overhead conveyor 7d, supplied at the picking station 13 and then loaded into the lying article loading aid 20c by the third robot 17c.

In another step, the dispatching of the articles 19a . . . 19d is finally done by conveying the loaded lying article loading aid 20c to the building opening 16 by the belt conveyors 18e and transporting it away from there.

It should be noted, once again, in this context that the example embodied above is purely illustrative, and there are numerous other possibilities of handling articles 19a . . . 19d in the storage and picking system 8.

Generally, the procedures in the storage and picking system 8 are controlled by a central control system 25. In the example shown, a radio connection to the conveying means of the storage and picking system 8 is indicated, yet also a wired communication is possible, of course. A material flow computer or a warehouse management system are specific exemplary embodiments of such a central control system 25.

The mobile measurement-value acquisition units 1a, 1a′ and 1b are moved through the storage and picking system 8 in the same way as the articles 19a . . . 19d, the lying article loading aids 20a . . . 20e and the hanging bags 21a . . . 21c.

It is hence advantageous if an exterior housing of the mobile measurement-value acquisition unit 1a, 1a′ and 1b is identical, in form and/or size, with a lying article loading aid 20a . . . 20e, or a hanging bag 21a . . . 21c, which serves the transport of articles and the storage of articles in the storage and picking system 8.

The mobile measurement-value acquisition unit 1a, 1a′ and 1b may in particular be designed as a modular system which can be integrated into different kinds of loading aids 20a . . . 20e, or hanging bags 21a . . . 21c. For example, at least the autarkic power supply 3, the central processing unit 4 and the sensors 5a . . . 5c of the mobile measurement-value acquisition unit 1a, 1a′ and 1b can be constructed on a base plate, or built into a base housing, which is then built into a lying article loading aid 20a . . . 20e, or into a hanging bag 21a . . . 21c. For example, the building-in can be done by strutting the base plate, or the base housing, in the lying article loading aid 20a . . . 20e, or in the hanging bag 21a . . . 21c, or by sticking, foaming or screwing the base plate, or the base housing, into the lying article loading aid 20a . . . 20e, or into the hanging bag 21a . . . 21c. In this case, the lying article loading aid 20a . . . 20e comprises the transport base A, or the hanging bag 21a . . . 21c comprises the suspended transport carrier 6, of the mobile measurement-value acquisition unit 1a, 1a′ and 1b.

A movement path along which the mobile measurement-value acquisition units 1a, 1a′ and lb are moved through the storage and picking system 8, therefore, extends along the transport paths formed by the conveying means, i.e. along the belt conveyors 18a . . . 18e and the overhead conveyors 7a . . . 7d, as well as along the movement paths of the storage-and-retrieval units 23a, 23b and of the autonomous guided vehicles 24a . . . 24d. Generally, also the robots 17a . . . 17c are counted among the transport network of the storage and picking system 8, provided that they are able to relocate the mobile measurement-value acquisition units 1a, 1a′ and 1b from one supply position to another supply position. In this case, the mobile measurement-value acquisition unit 1a, 1a′, 1b can be transported alternately standing upright/lying down on the belt conveyors 18a . . . 18e and in a suspended state on the overhead conveyors 7a . . . 7d.

Transport paths are not necessarily arranged rigidly but can also be formed flexibly or be changed, if required, by the autonomous guided vehicles 24a . . . 24d. A movement path can also include a storage location and/or a storage surface. Thus, practically all relevant locations (conveying sections and storage zones) in the storage and picking system 8 can be reached by the mobile measurement-value acquisition units 1a, 1a′ and 1b.

The movement paths of the mobile measurement-value acquisition units 1a, 1a′ and 1b can be specified, for example, by the superordinate central control system 25 (for example material flow computer or warehouse management system) of the storage and picking system 8. In this case, the superordinate central control system 25, therefore, coordinates not only the movements of the articles 19a . . . 19d, of the lying article loading aids 20a . . . 20e and of the hanging bags 21a . . . 21c, but the superordinate central control system 25 also specifies the movement paths of the mobile measurement-value acquisition units 1a, 1a′ and 1b. Alternatively, a movement path can also be specified by a mobile measurement-value acquisition unit 1a, 1a′, 1b itself, or by a remote control for the mobile measurement-value acquisition units 1a, 1a′ and 1b (in this context, see also FIG. 5). The movement paths can be specified randomly. The movement paths can alternatively also be specified by an operator.

Specifically, a movement and/or a transport of a mobile measurement-value acquisition unit 1a, 1a′, 1b is done on the transport surface of the motor-driven conveying means of the storage and picking system 8 along the movement path (cf. FIGS. 1 and 2). A mobile measurement-value acquisition unit 1a, 1a′ and 1b can also be stopped, i.e. deposited, laid or suspended, on the storage surface of the storage locations of the storage and picking system 8.

A measurement value, a temporal development of a measurement value and/or a local distribution of measurement values of a physical parameter (measured data) is acquired on the movement path with the help of the sensors 5a . . . 5c, and the location in the storage and picking system 8 on which the measurement value, its temporal development and/or its local distribution was acquired at a first point in time is stored.

Measured data can be transferred to a receiving device of an operator in real time, or they are stored temporarily and transferred to the receiving device at a later point in time. The transfer can be done, for example, via an air interface or a wired interface. The latter may in particular be provided at a charging station for the autarkic power supply of the mobile measurement-value acquisition unit 1a, 1a′ and 1b, which is called at periodically.

The acquisition of measured data by means of the mobile measurement-value acquisition unit 1a, 1a′ and 1b can be done during the transport movement or during standstill. For example, the mobile measurement-value acquisition unit 1a, 1a′ and 1b can be stopped on a storage location of the hanging-bag/hanging-article store 10 or the lying article store 12 and acquire measured data there, also over a longer period of time. For example, vibrations in the hanging-bag/hanging-article store 10, or in the lying article store 12, can be captured in this way.

Depending on the design of the sensors 5a . . . 5c,
an acoustic pressure may be provided as acquired physical parameter, and a measured loudness value, or an audio recording (and thus a temporal development of the acoustic pressure), may be acquired by a sensor 5a . . . 5c,
an amplitude or a frequency of a mechanical vibration may be provided as acquired physical parameter, and a measurement value for the amplitude and/or the frequency of the vibration may be acquired by a sensor 5a . . . 5c,
a temperature may be provided as acquired physical parameter, and a measured temperature value, or an infrared image (and thus a local distribution of the temperature), may be acquired by a sensor 5a . . . 5c,
a brightness and/or a color may be provided as acquired physical parameter, and a still image (local distribution of brightness and/or color), or a moving video recording (temporal development of the local distribution of brightness and/or color), may be acquired by a sensor 5a . . . 5c,
a concentration of a gas (in particular of oxygen) may be provided as acquired physical parameter, and a gas concentration may be acquired by a sensor 5a . . . 5c and/or
a time span may be provided as acquired physical parameter, and the time span may be ascertained by a time measuring device which the mobile measurement-value acquisition unit 1a, 1a′ and 1b requires for a movement from a first location to a second location.

If image data, or audio data, are recorded, it is of advantage if personal data are deleted, or rendered unrecognizable, in an audio recording and/or in a recording of a still, or moving, image. In this way, the protection of personal data can be ensured, for example if a conversation between individuals is inadvertently recorded.

Particularly advantageous is a variant of the method presented in which at least one measurement value, at least one temporal development of at least one measurement value and/or at least one local distribution of measurement values of a physical parameter, or of multiple physical parameters, are subjected to an analysis for detecting an anomaly, in terms of a deviation from a normal state. This enables pre-existing, or imminent, problems in the storage and picking system to be identified. For example, the acquisition of a measurement value, of a temporal development of a measurement value and/or of a local distribution of measurement values of the physical parameter acquired at the first point in time allows the detection of an anomaly in a storage and picking system 8 on essentially the same location at a second point in time. To that end, a deviation of the measurement value acquired at the first point in time from the measurement value acquired at the second point in time, the temporal development of the measurement value acquired at the first point in time from the temporal development of the measurement value acquired at the second point in time and/or the local distribution of the measurement values acquired at the first point in time from the local distribution of the measurement values acquired at the second point in time can be ascertained. If the ascertained deviation exceeds a specifiable threshold, a deviation notice is generated and issued.

Yet it is also conceivable that at least one measurement value, a temporal development of at least one measurement value and/or at least one local distribution of measurement values of a physical parameter, or multiple physical parameters, are subjected to an analysis for automatic detection of an anomaly using a statistical signal evaluation, or using a learning algorithm, and a deviation notice is generated and issued if an anomaly, in terms of a deviation from a normal state, has been identified. For example, slow changes in a time series of measurement values (“measurement-value drifts”) may be an indication of an imminent problem in the storage and picking system 8. But also rapid and strong variations in measurement values are often indicators of a (in particular pre-existing) problem in the storage and picking system 8. The statistical signal evaluation is especially suited for the analysis of measurement series of individual physical parameters, whereas learning algorithms (e.g. artificial neuronal networks, self-learning decision trees, genetic algorithms) are of advantage especially for the analysis of measurement series of a plurality of physical parameters.

A deviation notice is understood to be, in particular, acoustic and/or optical signals, as well as notifications to connected receiving devices, an e-mail, an SMS (“Short Message Service”), the setting of a flag or the issuing of an interruption signal. In terms of substance, the deviation notice may comprise the ascertained deviation itself (i.e. for example the difference between two measurement values), or also the mere information that there is a deviation. If an imminent, or even an existing, fault in the storage and picking system 8 can be assigned to the ascertained deviation, the deviation notice can also have the function of an alarm.

It is advantageous if an input prompt is addressed to a user at the same time as the deviation notice is issued and a piece of technical information of the user relating to an operating ability of the storage and picking system 8 is acquired at an input device and the piece of technical information is assigned to the deviation and stored in the database, or the piece of technical information is fed into an algorithm together with the deviation. The input device can be, for example, a mobile computing unit, for example a smartphone, a portable computer with a touch screen, or a keyboard, and suchlike. Yet evidently, also the use of fixed input terminals is conceivable. In this way, the experience of the plant operator can enter into the classification. Over time, a knowledge base can thus be compiled which helps swiftly and correctly assign anomalies occurring in the future to a piece of technical information. In particular, together with the acquisition of the piece of technical information, also a location or component assigned to the piece of technical information can be input, e.g. “defective bearing on conveyor roller number 7.”

A deviation, or multiple deviations, can be assigned a piece of technical information relating to the operating ability of the storage and picking system 8 in a database and/or by an algorithm (cf. also FIG. 5). There is, therefore, a classification of said deviation. This piece of technical information can be issued as a deviation notice, or together with the deviation notice, via an output unit (e.g. by means of optical and/or acoustic issuing).

The above-mentioned assignment is stored in the database and can be read out when this assignment is required. In contrast to this, in case the help of an algorithm is used, the above-mentioned assignment is done by computation. The algorithm can comprise a mathematical model of the storage and picking system 8, or a neuronal network, or be formed by same. Said piece of technical information relating to an operating ability of the storage and picking system 8 can comprise, for example, an indication of measurement values in the normal range, an indication of wear and tear, an indication of an imminent technical defect or an indication of an existing technical defect, or be formed by same. In this embodiment, the method presented thus comprises the function of an expert system.

For example,
an excessive temperature rise in the area of a roller or slide bearing (e.g. in the periphery of a conveyor roller 2) can be assigned a defective bearing as a piece of technical information,
a noise which is characteristic of a defective bearing can be assigned a defective bearing as a piece of technical information (to that end, a frequency spectrum can be ascertained from an audio recording with the help of a Fourier transformation, for example),
an excessive temperature rise in the area of an electronic circuit can be assigned an electric defect as a piece of technical information,
an excessive temperature rise in the area of a drive motor can be assigned a defective motor as a piece of technical information,
an excessive vibration can be assigned an undone or loosened screw connection as a piece of technical information,
an (optically captured) displacement of a screw head or a nut can be assigned an undone or loosened screw connection as a piece of technical information and/or
a below-average movement speed can be assigned excessive slip on the conveying means (e.g. due to an oiled-up conveyor roller 2) as a piece of technical information. In the above list, “defective” is to be understood to mean both an imminent and a pre-existing defect. In particular, an imminent defect is assigned different threshold values of an detected deviation of measured data, or of an detected anomaly, than a pre-existing defect.

The use of the mobile measurement-value acquisition unit 1a, 1a′ and 1b further allows for an detected anomaly, or an detected defect, to be characterized in more detail. The disruption, or the defect, in this embodiment, is not necessarily detected by the mobile measurement-value acquisition unit 1a, 1a′ and 1b but can be detected with the help of another sensor system provided (in particular installed so as to be stationary) in the storage and picking system. For a more detailed characterization of an detected anomaly, or of an detected defect, the mobile measurement-value acquisition unit 1a, 1a′ and 1b is transported to the location of the disruption, or of the defect, and a measurement value, a temporal development of a measurement value and/or a local distribution of measurement values of a physical parameter is acquired on said location. In this way, additional data relating to the disruption, or the defect, can be acquired. For example, infrared recordings, video recordings or audio recordings of the location for which a disruption, or a defect, has been ascertained can be made.

It is further advantageous if the piece of technical information and the deviation are fed into a learning algorithm and if the learning algorithm computes a correlation between the piece of technical information and the deviation, or multiple deviations, or a probability of the correctness of an assignment of the piece of technical information to the deviation, or multiple deviations, for a plurality of deviations. Over time, a knowledge base can thus be compiled and improved which helps swiftly and correctly assign anomalies occurring in the future to a piece of technical information.

In addition, it is of advantage if a probability of the correctness of the piece of technical information is issued together with this technical information and/or the piece of technical information is issued only if the probability of the correctness of the information exceeds a threshold value, i.e. if same is reliable. In this way, it is avoided that the operator of the storage and picking system 8 is mislead by a piece of technical information which is not confirmed and misinterprets the reported symptom. For example, an issuing may be “probably defective bearing” or “defective bearing with a probability of 75%.”It is also conceivable that the issuing below a value of 10% probability, for example, is suppressed.

It is generally also of advantage if the mobile measurement-value acquisition unit 1a, 1a′ and 1b can be switched to a display mode in which it is stopped by the conveying means of the storage and picking system 8 on the location on which an anomaly, or a deviation, above the specified threshold has been detected and issues an optical and/or acoustic signal there. In this way, the location of an detected anomaly, or an detected defect, can be displayed in the storage and picking system 8 in a simple manner

Further, it is of advantage if the mobile measurement-value acquisition unit 1a, 1a′ and lb, or a repair unit, can be switched to a repair mode in which it transports, with the help of the conveying means of the storage and picking system 8, spare parts and/or aids which serve to correct an detected defect to the location on which the defect has been detected. In this way, the workload on operating and maintenance personnel is reduced, as the spare parts, aids and tools required for a correction of an detected defect are transported, with the help of the conveying means, to the location on which the defect has been detected. The mobile measurement-value acquisition unit 1a, 1a′ and 1b can be equipped with a loading space for this purpose. A combination of the display mode and the repair mode is possible.

Generally, the acquisition of measured data can be done during operation of the storage and picking system 8. This means that articles 19a . . . 19d (in particular with the aid of lying article loading aids 20a . . . 20e and/or hanging bags 21a . . . 21c) and the mobile measurement-value acquisition units 1a, 1a′ and 1b are moved through the storage and picking system 8 simultaneously. The performance of the storage and picking system 8 is therefore not limited by the acquisition of the measured data.

Yet is it also conceivable that the acquisition of measured data is done in an analysis mode of the storage and picking system 8 in which the at least one mobile measurement-value acquisition unit 1a, 1a′ and 1b is moved alone in the storage and picking system 8. In this way, disruptive influences during the acquisition of measured data can be reduced and/or minimized For example, the acquisition of audio data is influenced by background noise only to a small degree. Said advantages also apply to the partial shut-down of the storage and picking system 8, of course, i.e. when the mobile measurement-value acquisition unit 1a, 1a′ and 1b moves alone in a sub-area of the storage and picking system 8.

It is further conceivable that a map of the storage and picking system 8 is made with the help of the positions ascertained for the measurement-value acquisition unit 1a, 1a′ and 1b, and the ascertained measurement values (e.g. a local distribution of measurement values), a deviation of the measurement value acquired at the first point in time from the measurement value acquired at the second point in time (e.g. a local distribution of deviations), a deviation notice, a piece of technical information, a disruption and/or a defect are marked on the map. In this way, the specified data can easily be depicted in graphic form.

Here, it is of advantage if the map of the storage and picking system 8 ascertained using the measurement-value acquisition unit 1a, 1a′ and 1b is matched against design data of the storage and picking system 8 (e.g. CAD data). In this way, the map of the storage and picking system 8 ascertained by the measurement-value acquisition unit 1a, 1a′ and 1b is harmonized (as much as possible) with design data of same. In this way, measurement errors during the acquisition of the position of the mobile measurement-value acquisition unit 1a, 1a′ and 1b on which the map is based can be corrected, for example.

In addition to this, FIG. 4 shows a simplified, functional diagram of the exemplary storage and picking system 8. Specifically, FIG. 4 shows an exemplary mobile measurement-value acquisition unit 1 having an autarkic power supply 3, a central processing unit 4 and multiple sensors 5a, 5b. The measurement-value acquisition unit 1 can be structured, for example, like the measurement-value acquisition unit 1a depicted in FIG. 1, like the measurement-value acquisition unit 1b depicted in FIG. 2, or also differently.

It is assumed in the example that the central processing unit 4 is connected to the autarkic power supply 3 and that the sensors 5a, 5b are connected to the central processing unit 4. In addition, it is assumed that the sensors 5a, 5b are supplied with energy by the central processing unit 4, unless they are passive sensors anyway.

Further, the mobile measurement-value acquisition unit 1 is connected, in terms of control technology, to the central control system 25 of the storage and picking system 8, which, in turn, is connected, in terms of control technology, to the conveying means of the storage and picking system 8, in this case with conveyor rollers 2a, 2b, by way of example.

Generally, it is conceivable in this constellation that the planning and computation of a movement path for the mobile measurement-value acquisition unit 1 are carried out by the central control system 25. It is further conceivable that the central control system 25 sends commands to the mobile measurement-value acquisition unit 1, for instance for switching on, or off, the acquisition of measured data. It is also conceivable that the central control system 25 receives measured data from the mobile measurement-value acquisition unit 1.

Yet the planning and computation of a movement path can also be done by the mobile measurement-value acquisition unit 1 itself. In this case, the mobile measurement-value acquisition unit 1 sends commands and/or requirements to the central control system 25 for the conveying means (conveyor rollers 2a, 2b) to be controlled such that the mobile measurement-value acquisition unit 1 is transported on the desired movement path.

The determining of the position of the mobile measurement-value acquisition unit 1 can equally be done in the mobile measurement-value acquisition unit 1 itself and/or via the central control system 25. For example, the locating of the mobile measurement-value acquisition unit 1 can be done with the help of the central control system 25 in the same way as the locating of the articles 19a . . . 19d, of the lying article loading aids 20a . . . 20e and of the hanging bags 21a . . . 21c. Yet the locating of the mobile measurement-value acquisition unit 1 can also be done, for example, by triangulation, distance measurement or travel-time measurement to known reference points, for instance with the help of indoor GPS, Bluetooth or WLAN.

FIG. 5 shows a configuration which is very similar to the configuration shown in FIG. 4. In contrast to this, the mobile measurement-value acquisition unit 1, in this example, is connected to a database 26 and to the two optional remote controls 27a, 27b. Furthermore, in addition to the storage and picking system 8a, also another storage and picking system 8b is connected to the database 26.

For example, further to a deviation of measured data, a piece of technical information relating to the operating ability of the storage and picking system 8 may be stored in the database 26 in the way described above. Also a model of the storage and picking system 8a, 8b, as well as executable code, may be stored in the database 26. For example, an algorithm, for example a neuronal network or fuzzy logic, which assigns a piece of technical information relating to the operating ability of the storage and picking system 8 to a deviation of measured data may be provided.

As depicted in FIG. 5, according to an advantageous embodiment, mobile measurement-value acquisition units 1 of multiple storage and picking systems 8a, 8b access the same database 26 and/or the same algorithm. In this way, the knowledge on the anomalies and defects occurring in multiple storage and picking systems 8a, 8b can be pooled in one place and also be exchanged. This enables the operating personnel of the storage and picking system 8a to benefit from the knowledge accumulated in the storage and picking system 8b, and vice versa.

The remote controls 27a, 27b are configured
for receiving a measurement value, a temporal development of a measurement value and/or a local distribution of measurement values of a physical parameter, as well as
for transmitting control commands to the mobile measurement-value acquisition unit 1, as well as to the conveying means (in this case conveyor rollers 2a, 2b) of the storage and picking system 8 with which the mobile measurement-value acquisition unit 1 is moved.

The remote controls 27a, 27b can be used for taking over the control of the mobile measurement-value acquisition unit 1. To that end, the remote controls 27a, 27b, in this example, are connected to the superordinate central control system 25 of the storage and picking system 8 (e.g. to a material flow computer or a warehouse management system) in order to be able to prompt a targeted movement of the conveying means of the storage and picking system 8.

For example, a route, or movement path, on which the mobile measurement-value acquisition unit 1 is to be moved through the storage and picking system 8a is specified, or preprogrammed, in real time. In particular, also the mere specification of waypoints which the mobile measurement-value acquisition unit 1 is to pass is possible. The specific implementation, i.e. the determination of a movement path and/or route which contains these waypoints, is left up to the superordinate central control system 25 of the storage and picking system 8a and/or is done by same.

If a control is done in real time, the mobile measurement-value acquisition unit 1, as well as the conveying means of the storage and picking system 8 (in this case indirectly via the central control system 25), receive control commands from the remote control 27a, 27b and execute same.

Here, the measured data can be transferred to the remote control 27a, 27b in real time, or the measured data are stored temporarily and transferred to the remote control7a, 27b at a later point in time. Instead of the remote control 27a, 27b, or additionally to it, also a different receiving device for receiving the measured data may be provided.

As can be seen in FIG. 5, the remote control 27b may also be arranged outside of the storage and picking system 8a. Generally, there is therefore the possibility of a central monitoring point for a plurality of storage and picking systems 8a, 8b if also the storage and picking system 8b is configured for operation with an external remote control 27b. In particular in combination with the database 26, the knowledge on the anomalies and defects occurring in multiple storage and picking systems 8a, 8b can be pooled on one location, whereby the maintenance requirements for a plurality of storage and picking systems 8a, 8b are reduced.

FIG. 6 shows an exemplary suspended transport carrier 6a in an oblique view. The suspended transport carrier 6a can be driven along the overhead conveyors 7, 7a . . . 7d, or be moved in a driven manner in a first conveying section and in a non-driven manner in a second conveying section. The suspended transport carrier 6a may comprise a base body 28 and one, or multiple, pulleys 29 mounted on same so as to be rotatable. Further, the suspended transport carrier 6a may comprise an adapter reception 30 into which, optionally, a first overhead adapter 31a or a second overhead adapter 3 1b can be inserted. (A) hanging article(s) can be suspended on the first overhead adapter 31a via a coat hanger. The second overhead adapter 31b is provided for a hanging bag 21a . . . 21c on which second overhead adapter 31b the hanging bag 21a . . . 21c can be suspended via a hanger. Yet (a) hanging article(s) could generally also be suspended on the second overhead adapter 31b. The suspended transport carrier 6a is not limited to the design depicted in FIG. 6 but could also be configured differently. In particular, the suspended transport carrier 6a can also be formed as one piece.

FIG. 7 finally shows a possible embodiment of a (self-propelled) autonomous guided vehicle 24 (“AGV,” or “AMR”) in an oblique view. The autonomous guided vehicle 24 comprises a chassis 32 with a drive unit and a loading platform 33 arranged on the chassis 32 for receiving, dispensing and transporting (an) article(s) 19a . . . 19i, a lying article loading aid 20a . . . 20e or a mobile measurement-value acquisition unit 1a, 1a′, 1b (not depicted in FIG. 7). In this case, the top side of the loading platform 33, therefore, forms a transport surface on which a lying article loading aid 20a . . . 20e (or also a hanging bag 21a . . . 21c), or the mobile measurement-value acquisition unit 1a, can be deposited. It would also be conceivable that the autonomous guided vehicle 24, additionally or alternatively, comprises a hanger rod which forms a transport surface on which the hanging bags 21a . . . 21c, or the mobile measurement-value acquisition unit 1b, can be suspended. The autonomous guided vehicle 24, therefore, serves the transport of the article(s) 19a . . . 19i, of the lying article loading aid 20a . . . 20e, of the hanging bags 21a . . . 21c or of the mobile measurement-value acquisition unit 1a, 1a′, 1b.

The drive unit comprises wheels 34, 35 mounted on the chassis 32 so as to be rotatable, at least one of which wheels 34 is coupled with a drive (not depicted), and at least one of which wheels 35 is steerable. It is also possible for both wheels 34, 35 to be coupled with the drive and driven by same. Yet the autonomous guided vehicle 24 may also comprise four wheels, two of which wheels are steerable. According to the embodiment shown, the loading platform 33 is mounted on the chassis 32 so as to be adjustable between an initial position (marked in solid lines) and a transport position (marked in dashed lines).

In the initial position, (an) article(s) 19a . . . 19i, a lying article loading aid 20a . . . 20e or a mobile measurement-value acquisition unit 1a, 1a′, 1b can be traveled underneath in order to receive same. If the loading platform 33 is adjusted from the initial position in a direction of the transport position, the article(s) 19a . . . 19i, the lying article loading aid 20a . . . 20 or the mobile measurement-value acquisition unit 1a, 1a′, 1b can be lifted, and afterward transported. If the loading platform 33 is readjusted from the transport position in a direction of the initial position, the article(s) 19a . . . 19i, the lying article loading aid 20a . . . 20 or the mobile measurement-value acquisition unit 1a, 1a′, 1b can be deposited, or dispensed, again. Evidently, (an) article(s) 19a . . . 19i, a lying article loading aid 20a . . . 20e or a mobile measurement-value acquisition unit 1a, 1a′, 1b can also simply be laid onto the transport surface of the loading platform 33.

The autonomous guided vehicle 24 further comprises a drive control 36, schematically depicted in dashed lines, for receiving commands from the central control system 25 and for controlling/regulating the movements of the autonomous guided vehicle 24. The drive control 36 may also comprise means for the (wireless) data transfer to, and from, the autonomous guided vehicle 24. Finally, the autonomous guided vehicle 24 comprises sensors (not depicted) for acquiring the environment of the autonomous guided vehicle 24 and for spatial orientation. The drive of the drive unit, and the sensors, are connected to the drive control 36.

Finally, it should be noted that the scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

In particular, it should also be noted that, in reality, the depicted devices can also comprise more, or also fewer, components than depicted. In some cases, the shown devices and/or their components may not be depicted to scale and/or be enlarged and/or reduced in size.

### LIST OF REFERENCE NUMBERS

1, 1a, 1a′, 1b mobile measurement-value acquisition unit

2, 2a, 2b conveyor roller (conveying means)

3 autarkic power supply

4 central processing unit

5a . . . 5c sensor

6, 6a suspended transport carrier

7, 7a . . . 7d overhead conveyor

8, 8a, 8b storage and picking system

9 first loading station

10 hanging-bag/hanging-article store

11 second loading station

12 lying article store

13 picking station

14 building

15 building opening

16 building opening

17a . . . 17c robot

18a . . . 18e belt conveyor

19a . . . 19i article(s)

20a . . . 20e lying article loading aid

21a . . . 21c hanging bag

22 storage rack

23a, 23b storage-and-retrieval unit

24, 24a . . . 24d autonomous guided vehicle

25 central control system of the storage and picking system

26 database

27a, 27b remote control

28 base body

29 pulleys

30 adapter reception

31a, 31b overhead adapter

32 chassis

33 loading platform

34 wheel (driven)

35 wheel (steerable)

36 drive control

37 charging station

A transport base

1-40. (canceled)

41. A storage and picking system (8, 8a, 8b), comprising
a storage zone (10, 12) having a plurality of storage locations which form a storage surface for storing articles (19a . . . 19i);
at least one workstation (13) for picking and/or repacking the articles (19a . . . 19i);
conveying device(s) with motor-driven conveying means (2 . . . 2b, 7 . . . 7d, 17a . . . 17c, 18a . . . 18e, 23a, 23b, 24 . . . 24d) which have a moving transport surface, or form same, and which are configured for transporting the articles (19a . . . 19i) on this transport surface inside the storage and picking system (8, 8a, 8b);
a mobile measurement-value acquisition unit (1, 1a, 1a′, 1b), comprising an autarkic power supply (3), a central processing unit (4) connected to the autarkic power sup-ply (3) and multiple sensors (5a . . . 5c) connected to the central processing unit (4), wherein the mobile measurement-value acquisition unit (1, 1a, 1a′, 1b):
is configured for acquiring a measurement value, a temporal development of a measurement value and/or a local distribution of measurement values of a physical parameter on a movement path of the mobile measurement-value acquisition unit (1, 1a, 1a′, 1b) in the storage and picking system (8, 8a, 8b) with the help of the sensors (5a . . . 5c),
is configured for storing a location in the storage and picking system (8, 8a, 8b) on which the measurement value, its temporal development and/or its local distribution was acquired and
is configured for a transport on the transport surface of the motor-driven conveying means (2 . . . 2b, 7 . . . 7d, 17a . . . 17c, 18a . . . 18e, 23a, 23b, 24 . . . 24d) of the storage and picking system (8, 8a, 8b) along the movement path and/or for an intermediate stop on the storage surface of the storage locations of the storage and picking system (8, 8a, 8b) which is situated on the movement path;
wherein-the storage and picking system (8, 8a, 8b) is configured for carrying out a locating of the mobile measurement-value acquisition unit (1, 1a, 1a′, 1b) by determining a relative position of the mobile measurement-value acquisition unit (1, 1a, 1a′, 1b) on the basis of a reference location;
wherein a displacement measurement on the basis of the reference point is done a) with the help of a displacement sensor built into the mobile measurement-value acquisition unit (1, 1a, 1a′, 1b) or b) by using route signals of the moving transport surface and/or by using rotation signals which are read out in motor drives of the conveying means (2 . . . 2b, 7 . . . 7d, 17a . . . 17c, 18a . . . 18e, 23a, 23b, 24 . . . 24d).

42. The storage and picking system (8, 8a, 8b) according to claim 41, wherein the conveying means comprise stationary, motor-driven conveying means (2 . . . 2b, 7 . . . 7d, 17a . . . 17c, 18a . . . 18e, 23a, 23b,) and/or mobile, motor-driven conveying means (24 . . . 24d) for transporting articles (19a . . . 19i) and the mobile measurement-value acquisition unit (1, 1a, 1a′, 1b).

43. The storage and picking system (8, 8a, 8b) according to claim 41, wherein the mobile measurement-value acquisition unit (1, 1a, 1a′, 1b) has no motor drive for its movement.

44. The storage and picking system (8, 8a, 8b) according to claim 41, wherein the sensors (5a . . . 5c) of the mobile measurement-value acquisition unit (1, 1a, 1a′, 1b) comprise a microphone, a vibration sensor or an acceleration sensor, a temperature sensor, an infrared camera, a camera for the visible wavelength range, a tilt sensor, an RFID transponder, sensors for the triangulation, distance measurement or travel-time measurement and/or a gas sensor.

45. The storage and picking system (8, 8a, 8b) according to claim 41, wherein the mobile measurement-value acquisition unit (1, 1a, 1a′) has a transport base (A) with whose help the mobile measurement-value acquisition unit (1, 1a, 1a′, 1b) can be transported standing upright or lying on the transport surface of the conveying means (2 . . . 2b, 7 . . . 7d, 17a . . . 17c, 18a . . . 18e, 23a, 23b, 24 . . . 24d) of the storage and picking system (8, 8a, 8b).

46. The storage and picking system (8, 8a, 8b) according to claim 41, wherein the mobile measurement-value acquisition unit (1b) has a suspended transport carrier (6, 6a) with whose help the mobile measurement-value acquisition unit (1, 1a, 1a′, 1b) can be transported in a suspended state on the transport surface of the conveying means (2 . . . 2b, 7 . . . 7d, 17a . . . 17c, 18a . . . 18e, 23a, 23b, 24 . . . 24d) of the storage and picking system (8, 8a, 8b).

47. The storage and picking system (8, 8a, 8b) according to claim 41, wherein an exterior housing of the mobile measurement-value acquisition unit (1, 1a, 1a′, 1b) is identical, in form and/or size, with a loading aid (20a . . . 20e, 21a . . . 21c) which serves the transport of articles and the storage of articles in the storage and picking system (8, 8a, 8b).

48. The storage and picking system (8, 8a, 8b) according to claim 41, wherein same has a database (26) and/or an algorithm which is configured for ascertaining an assignment of a piece of technical information relating to an operating ability of the storage and picking system (8, 8a, 8b) to a deviation of the measurement value acquired at the first point in time from the measurement value acquired at the second point in time, of the temporal development of the measurement value acquired at the first point in time from the temporal development of the measurement value acquired at the second point in time and/or of the local distribution of the measurement values acquired at the first point in time from the local distribution of the measurement values acquired at the second point in time.

49. The storage and picking system (8, 8a, 8b) according to claim 41, wherein same comprises a remote control (27a, 27b) which
is configured for receiving a measurement value, a temporal development of a measurement value and/or a local distribution of measurement values of a physical parameter; and
is configured for transmitting control commands to the mobile measurement-value acquisition unit (1, 1a, 1a′, 1b), as well as to the conveying means (2 . . . 2b, 7 . . . 7d, 17a . . . 17c, 18a . . . 18e, 23a, 23b, 24 . . . 24d), of the storage and picking system (8, 8a, 8b) with which the mobile measurement-value acquisition unit (1, 1a, 1a′, 1b) is moved.

50. The storage and picking system (8, 8a, 8b) according to claim 41, further comprising a charging station (37) for an autarkic power supply (3) of the mobile measurement-value acquisition unit (1, 1a, 1a′, 1b).

51. The storage and picking system (8, 8a, 8b) according to claim 41, further comprising a computer-aided evaluation unit which is configured to subject at least one measurement value, at least one temporal development of at least one measurement value and/or at least one local distribution of measurement values of a physical parameter, or of multiple physical parameters, to an analysis for detecting an anomaly, in terms of a deviation from a normal state.

52. A mobile measurement-value acquisition unit (1, 1a, 1a′, 1b) for a storage and picking system (8, 8a, 8b) operated in an automated manner, comprising an autarkic power supply (3), a central processing unit (4) connected to the autarkic power supply (3) and multiple sensors (5a . . . 5c) connected to the central processing unit (4), wherein the mobile measurement-value acquisition unit (1, 1a, 1a′, 1b):
is configured for acquiring a measurement value, a temporal development of a measurement value and/or a local distribution of measurement values of a physical parameter on a movement path of the mobile measurement-value acquisition unit (1, 1a, 1a′, 1b) in a storage and picking system (8, 8a, 8b) with the help of the sensors (5a . . . 5c),
is configured for storing a location in the storage and picking system (8, 8a, 8b) on which the measurement value, its temporal development and/or its local distribution was acquired, and
is configured for a transport on a transport surface of motor-driven conveying means (2 . . . 2b, 7 . . . 7d, 17a . . . 17c, 18a . . . 18e, 23a, 23b, 24 . . . 24d) of the storage and picking system (8, 8a, 8b) along the movement path and/or for an intermediate stop on a storage surface of storage locations of the storage and picking system (8, 8a, 8b) which is situated on the movement path;
wherein
the mobile measurement-value acquisition unit (1, 1a, 1a′, 1b) is configured for carrying out a locating by determining a relative position on the basis of a reference location, wherein a displacement measurement on the basis of the reference point is done with the help of a displacement sensor built into the mobile measurement-value acquisition unit (1, 1a, 1a′, 1b).

53. A method for acquiring measurement values in a storage and picking system (8, 8a, 8b) having a storage zone (10, 12) with a plurality of storage locations which form a storage surface for storing articles (19a . . . 19i), at least one workstation (13) for picking and/or repacking the articles (19a . . . 19i), and conveying device(s) with motor-driven conveying means (2 . . . 2b, 7 . . . 7d, 17a . . . 17c, 18a . . . 18e, 23a, 23b, 24 . . . 24d) which have a moving transport surface, or form same, and which are configured for transporting the articles (19a . . . 19i) on this transport surface inside the storage and picking system (8, 8a, 8b), comprising the steps:
moving a mobile measurement-value acquisition unit (1, 1a, 1a′, 1b) which comprises an autarkic power supply (3), a central processing unit (4) connected to the autarkic power supply (3) and multiple sensors (5a . . . 5c) connected to the central processing unit (4) along a movement path in the storage and picking system (8, 8a, 8b);
acquiring a measurement value, a temporal development of a measurement value and/or a local distribution of measurement values of a physical parameter on a movement path with the help of the sensors (5a . . . 5c) and storing a location in the storage and picking system (8, 8a, 8b) on which the measurement value, its temporal development and/or its local distribution was acquired, at a first point in time; and
transporting the mobile measurement-value acquisition unit (1, 1a, 1a′, 1b) on the transport surface of the motor-driven conveying means (2 . . . 2b, 7 . . . 7d, 17a . . . 17c, 18a . . . 18e, 23a, 23b, 24 . . . 24d) of the storage and picking system (8, 8a, 8b) along the movement path and/or stopping the mobile measurement-value acquisition unit (1, 1a, 1a′, 1b) on the storage surface of the storage locations of the storage and picking system (8, 8a, 8b) which is situated on the movement path;
wherein:
a locating of the mobile measurement-value acquisition unit (1, 1a, 1a′, 1b) is done by determining a relative position of the mobile measurement-value acquisition unit (1, 1a, 1a′, 1b) on the basis of a reference location; and
a displacement measurement on the basis of the reference point is done a) with the help of a displacement sensor built into the mobile measurement-value acquisition unit (1, 1a, 1a′, 1b) or b) by using route signals of the moving transport surface and/or by using rotation signals which are read out in motor drives of the conveying means (2 . . . 2b, 7 . . . 7d, 17a . . . 17c, 18a . . . 18e, 23a, 23b, 24 . . . 24d).

54. The method according to claim 53, wherein:
an acoustic pressure is provided as physical parameter, and a measured loud-ness value, or an audio recording, is acquired by a sensor (5a . . . 5c);
an amplitude or a frequency of a mechanical vibration is provided as physical parameter, and a measurement value for the amplitude and/or the frequency of the vibration is acquired by a sensor (5a . . . 5c);
a temperature is provided as physical parameter, and a measured temperature value, or an infrared image, is acquired by a sensor (5a . . . 5c);
a brightness and/or a color is provided as physical parameter, and a still image, or a moving video recording, is acquired by a sensor (5a . . . 5c);
a concentration of a gas is provided as physical parameter, and a gas concentration is acquired by a sensor (5a . . . 5c); and/or
a time span is provided as physical parameter, and the time span is ascertained by a time measuring device which the mobile measurement-value acquisition unit (1, 1a, 1a′, 1b) requires for a movement from a first location to a second location.

55. The method according to claim 53, wherein at least one measurement value, at least one temporal development of at least one measurement value and/or at least one local distribution of measurement values of a physical parameter, or of multiple physical parameters, is subjected to an analysis for detecting an anomaly, in terms of a deviation from a normal state.

56. The method according to claim 53, comprising the additional steps:
acquiring a measurement value, a temporal development of a measurement value and/or a local distribution of measurement values of this physical parameter along the movement path with the help of the sensors (5a . . . 5c) on essentially the same location at a second point in time; and
ascertaining a deviation of the measurement value acquired at the first point in time from the measurement value acquired at the second point in time, of the temporal development of the measurement value acquired at the first point in time from the temporal development of the measurement value acquired at the second point in time and/or of the local distribution of the measurement values acquired at the first point in time from the local distribution of the measurement values acquired at the second point in time, and generating and issuing a deviation notice if the ascertained deviation exceeds a specifiable threshold.

57. The method according to claim 55, wherein at least one measurement value, a temporal development of at least one measurement value and/or at least one local distribution of measurement values of a physical parameter, or of multiple physical parameters, is subjected to an analysis for automatic detection of an anomaly using a statistical signal evaluation, or using a learning algorithm of the storage and picking system (8, 8a, 8b), and a deviation notice is generated and issued if an anomaly, in terms of a deviation from a normal state, has been identified.

58. The method according to claim 56, wherein an input prompt is addressed to a user when the deviation notice is issued and a piece of technical information of the user relating to an operating ability of the storage and picking system (8, 8a, 8b) is acquired at an input device and the piece of technical information is assigned to the deviation and stored in the database (26), or the piece of technical information is fed into an algorithm together with the deviation.

59. The method according to claim 56, wherein a piece of technical information relating to an operating ability of the storage and picking system (8, 8a, 8b) is assigned to a deviation, or multiple deviations, in a database (26) and/or by means of an algorithm and this technical information is issued as a deviation notice, or together with the deviation notice.

60. The method according to claim 58, wherein:
an excessive temperature rise in the area of a roller or slide bearing is assigned a defective bearing as a piece of technical information;
a noise which is characteristic of a defective bearing is assigned a defective bearing as a piece of technical information;
an excessive temperature rise in the area of an electronic circuit is assigned an electric defect as a piece of technical information;
an excessive temperature rise in the area of a drive motor is assigned a defective motor as a piece of technical information;
an excessive vibration is assigned an undone or loosened screw connection as a piece of technical information;
a displacement of a screw head or a nut is assigned an undone or loosened screw connection as a piece of technical information; and/or
a below-average movement speed is assigned excessive slip on the conveying means (2 . . . 2b, 7 . . . 7d, 17a . . . 17c, 18a . . . 18e, 23a, 23b, 24 . . . 24d) as a piece of technical information.

61. The method according to claim 58, wherein the piece of technical information and the deviation are fed into a learning algorithm of the storage and picking system (8, 8a, 8b) and wherein the learning algorithm computes a correlation between the piece of technical information and the deviation, or multiple deviations, or a probability of a correctness of the assignment of the piece of technical information to the deviation, or multiple deviations, for a plurality of deviations.

62. The method according to claim 58, wherein a probability of the correctness of the piece of technical information is issued together with this technical information and/or the piece of technical information is issued only if the probability of the correctness of the information exceeds a threshold value.

63. The method according to claim 58, wherein mobile measurement-value acquisition units (1, 1a, 1a′, 1b) of multiple storage and picking systems (8, 8a, 8b) use the same database (26) and/or the same algorithm.

64. The method according to claim 53, wherein an audio recording is acquired by a sensor (5a . . . 5c) and a frequency spectrum is ascertained from it with the help of a Fourier transformation.

65. The method according to claim 53, wherein the mobile measurement-value acquisition unit (1, 1a, 1a′) is transported standing upright or lying down on the transport surface of the conveying means (2 . . . 2b, 7 . . . 7d, 17a . . . 17c, 18a . . . 18e, 23a, 23b, 24 . . . 24d) of the storage and picking system (8, 8a, 8b).

66. The method according to claim 53, wherein the mobile measurement-value acquisition unit (1b) is transported in a suspended state on the transport surface of the conveying means (2 . . . 2b, 7 . . . 7d, 17a . . . 17c, 18a . . . 18e, 23a, 23b, 24 . . . 24d) of the storage and picking system (8, 8a, 8b).

67. The method according to claim 65, wherein the mobile measurement-value acquisition unit (1, 1a, 1a′, 1b) is transported alternately standing up-right/lying down and in a suspended state on the transport surface of the conveying means (2 . . . 2b, 7 . . . 7d, 17a . . . 17c, 18a . . . 18e, 23a, 23b, 24 . . . 24d) of the storage and picking system (8, 8a, 8b).

68. The method according to claim 65, wherein the mobile measurement-value acquisition unit (1, 1a, 1a′, 1b) can be switched to a display mode in which it is stopped by the conveying means (2 . . . 2b, 7 . . . 7d, 17a . . . 17c, 18a . . . 18e, 23a, 23b, 24 . . . 24d) of the storage and picking system (8, 8a, 8b) on the location on which an anomaly, or a deviation above the specified threshold, has been detected, and issues an optical and/or acoustic signal there via an output unit.

69. The method according to claim 65, wherein the mobile measurement-value acquisition unit (1, 1a, 1a′, 1b), or a repair unit, can be switched to a repair mode in which it transports, with the help of the conveying means (2 . . . 2b, 7 . . . 7d, 17a . . . 17c, 18a . . . 18e, 23a, 23b, 24 . . . 24d) of the storage and picking system (8, 8a, 8b), spare parts and/or aids in a loading space which serve to correct an detected defect to the location on which the defect has been detected.

70. The method according to claim 69, wherein the mobile measurement-value acquisition unit (1, 1a, 1a′, 1b), in the repair mode, issues an optical and/or acoustic signal via an output unit on the location on which the defect has been detected.

71. The method according to claim 53, wherein a measurement value, a temporal development of a measurement value and/or a local distribution of measurement values of a physical parameter are transmitted to a remote control (27a, 27b), and the mobile measurement-value acquisition unit (1, 1a, 1a′, 1b), as well as the conveying means (2 . . . 2b, 7 . . . 7d, 17a . . . 17c, 18a . . . 18e, 23a, 23b, 24 . . . 24d) of the storage and picking system (8, 8a, 8b) with which the mobile measurement-value acquisition unit (1, 1a, 1a′, 1b) is moved, receive and execute control commands from this remote control (27a, 27b).

72. The method according to claim 53, wherein the acquisition of a measurement value, of a temporal development of a measurement value and/or of a local distribution of measurement values of a physical parameter is done during operation of the storage and picking system (8, 8a, 8b) in which articles (19a . . . 19i) and the mobile measurement-value acquisition unit (1, 1a, 1a′, 1b) are transported simultaneously in the storage and picking system (8, 8a, 8b).

73. The method according to claim 53, wherein the acquisition of a measurement value, of a temporal development of a measurement value and/or of a local distribution of measurement values of a physical parameter is done in an analysis mode of the storage and picking system (8, 8a, 8b) in which the mobile measurement-value acquisition unit (1, 1a, 1a′, 1b) is moved alone in the storage and picking system (8, 8a, 8b).

74. The method according to claim 53, wherein:
a disruption or a defect in the storage and picking system (8, 8a, 8b) is detected and the location of the disruption or of the defect is ascertained;
the mobile measurement-value acquisition unit (1, 1a, 1a′, 1b) is transported to said location with the conveying means (2 . . . 2b, 7 . . . 7d, 17a . . . 17c, 18a . . . 18e, 23a, 23b, 24 . . . 24d) of the storage and picking system (8, 8a, 8b); and
a measurement value, a temporal development of a measurement value and/or a local distribution of measurement values of a physical parameter is acquired by the sensor (5a . . . 5c) on said location.

75. The method according to claim 53, wherein personal data are deleted, or rendered unrecognizable, in an audio recording and/or in a recording of a still, or moving, image which was made by the sensor (5a . . . 5c).

76. The method according to claim 53, wherein a locating of the mobile measurement-value acquisition unit (1, 1a, 1a′, 1b) is done with light barriers, cameras, barcode readers and/or RFID readers which are arranged along the conveying device(s) or near the storage locations.

77. The method according to claim 53, wherein a map of the storage and picking system (8, 8a, 8b) is made with the help of the positions ascertained for the measurement-value acquisition unit (1, 1a, 1a′, 1b), and the ascertained measurement values, a deviation of the measurement value acquired at the first point in time from the measurement value acquired at the second point in time, a deviation notice, a piece of technical information, a disruption and/or a defect are marked on the map.

78. The method according to claim 77, wherein the map of the storage and picking system (8, 8a, 8b) ascertained with the measurement-value acquisition unit (1, 1a, 1a′, 1b) is matched against design data of the storage and picking system (8, 8a, 8b).
